(19) United States
(12) Patent Application Publication
(10) Pub. No.: US 2026/0341969 A1
(43) Pub. Date: Oct. 29, 2026

(54) ANTENNA DEVICE AND ANTENNA DEVICE ATTACHED STRUCTURE

(71) Applicant: CITY UNIVERSITY OF HONG KONG, Kowloon (HK)

(72) Inventors: Kwok Wa LEUNG, Kowloon (HK); Wai Ki LEE, Yuen Long (HK)

(21) Appl. No.: 19/193,242

(22) Filed: Apr. 29, 2025

(51) Int. Cl. H01Q 15/00; H01Q 1/12; H01Q 9/04

(52) U.S. Cl. CPC H01Q 15/0086; H01Q 1/1271; H01Q 9/04

(57) ABSTRACT

An antenna device for attaching to a structure, which includes a dielectric radiation element unit adapted to be positioned on an interior side of a window glass; and a dielectric wave-directing matching member that is either part of the dielectric radiation element or a separate component, which is adapted to be arranged between the window glass and the dielectric radiation element, or on a second side of the window glass; and at least one an electromagnetic wave reflector arranged to position on the interior side of the dielectric radiation element, located further from the interior side of the window glass; and an antenna signal feeding circuit configured to transmit electromagnetic signals to or receive electromagnetic signals from a dielectric radiation element for signal transmission or reception; wherein the antenna unit element is configured to accommodate and match the thickness and dielectric constant of the window glass where attached.

### TECHNICAL FIELD

The invention relates to an antenna unit for attaching to a surface (such as the surface of a window glass of a target object), and a structure with such an antenna unit.

### BACKGROUND

FIG. 1 illustrates electromagnetic wave 10 transitioning from one side to another through a medium within an environment. Electromagnetic wave 10 can either emanate from an antenna (not shown) or be configured to be received by one. In this instance, the medium possesses a different dielectric constant or permittivity (εᵣ₂) compared to that of the surrounding environment, resulting in part of electromagnetic wave 10 being reflected at the interface between the medium and the environment, while the remainder is transmitted through the medium. Generally, a larger disparity in dielectric constant or permittivity correlates with increased reflection of the electromagnetic wave.

Regarding the incidence plane of the passing wave, it can be analyzed by decomposing it into parallel and perpendicular electric field vector components. This decomposition aids in investigating the reflection and transmission coefficients of the wave.

In particular, assuming the thickness of the dielectric medium is εᵣ₂, the input reflection coefficient at the boundary (z=−t⁻) can be represented as follows:

$${Γ}_{in} ( z = - {t}^{-} ) = \frac{( \frac{\sqrt{{ε}_{r 1}} - \sqrt{{ε}_{r 2}}}{\sqrt{{ε}_{r 1}} + \sqrt{{ε}_{r 2}}} ) + ( \frac{\sqrt{{ε}_{r 2}} - \sqrt{{ε}_{r 3}}}{\sqrt{{ε}_{r 2}} + \sqrt{{ε}_{r 3}}} ) {e}^{- j \frac{4 π \sqrt{{ε}_{r 2}}}{{λ}_{0}} t}}{1 + ( \frac{\sqrt{{ε}_{r 1}} - \sqrt{{ε}_{r 2}}}{\sqrt{{ε}_{r 1}} + \sqrt{{ε}_{r 2}}} ) + ( \frac{\sqrt{{ε}_{r 2}} - \sqrt{{ε}_{r 3}}}{\sqrt{{ε}_{r 2}} + \sqrt{{ε}_{r 3}}} ) {e}^{- j \frac{4 π \sqrt{{ε}_{r 2}}}{{λ}_{0}} t}} \qquad ( 1 )$$

Here, t denotes the thickness of the dielectric layer εᵣ₂, λ₀ is the free space wavelength, and εᵣ₁ and εᵣ₃ are the dielectric constants of the incident and outlet media, respectively. Note that λ_{G}=λ₀/\sqrt{εᵣ₂} signifies the wavelength within the medium.

Applying the above formula (1) and setting εᵣ₂ equal to εᵣ₃, implies a substantial thickness t of the medium. Consequently, the formula simplifies as follows:

$${Γ}_{in} ( z = - {t}^{-} ) = ( \frac{\sqrt{{ε}_{r 1}} - \sqrt{{ε}_{r 2}}}{\sqrt{{ε}_{r 1}} + \sqrt{{ε}_{r 2}}} ) \qquad ( 2 )$$

If εᵣ₁×5=εᵣ₂, the reflection coefficient is nearly −38%. If εᵣ₁×4=εᵣ₂, the reflection coefficient is nearly −33.3%.

However, practically, the value of t will not be zero. In a scenario where εᵣ₂ is greater than both εᵣ₁ and εᵣ₃, the reflection decreases as t diminishes. If t exceeds λ₀/4, the function becomes periodic with λ_{G}. In practical applications, achieving less than 20% reflection is considered low. A significant transmission loss occurs when the difference in dielectric constants of the resonator exceeds 3, resulting in more than 24% reflection.

In prior art, US patent publication US20210005951 presents a strategy involving a wave direction member and a matching medium introduced to mitigate reflection and improve the Front-to-Back (FB) ratio. FIG. 3 of the '951 document illustrates its characteristic structure. The key technological approach to address this issue involves adjusting the distance defined between the interior edge of the window glass and the radiation element, which is denoted as D along the radiation direction R. Although the rationale behind selecting D is not explicitly mentioned in the '951 document, it is generally understood to adhere to a reflection guide that necessitates a proximity of nλg (where n is zero or a higher integer) between the interior edge of the window glass and the radiating element's surface. This is based on the assumption that reflection occurs on the indoor surface of the glass.

In a related patent publication US20220200156, the extended use of the original concept in the '951 document is elaborated. The '156 document discloses an antenna unit designed for installation facing a building's window glass, including a radiating element, a phase control member on the exterior side of the radiating element to modulate the phase of the emitted electromagnetic wave, and a conductor on the interior side. The phase control member consists of a dielectric and several conductor parts, primarily adjusting the phase of the electromagnetic wave emitted from the radiating element. This adjustment alters the emission direction of the electromagnetic wave, increasing the difference in gain between the main and grating lobes of the antenna unit. The phase control member is a composite of a dielectric member and a wave-directing component.

A crucial aspect of the '156 document is its consistency with the earlier '951 document's requirements, particularly where the distance between the radiating element and the wave-directing member, labeled as a, and the relative permittivity of the dielectric medium between these components, denoted as εᵣ, must be at least (2.11×εᵣ−1.82) mm to enhance gain difference. This suggests that their radiating elements are not loaded with dielectric material and necessitate a spatial separation from the wave-directing member to facilitate effective radiation. Furthermore, the '156 document addresses the importance of controlling the distance D, which pertains to the gap between the radiating element and the window glass's interior edge. The primary aim of the '156 document is to modulate the phase delay to optimize the gain and directional control of the main lobe in an antenna array.

### SUMMARY OF THE INVENTION

In a first aspect of the invention, there is provided an antenna unit for attaching to the window glass of a target object. The antenna unit includes a radiation element, a wave-directing matching member and an electromagnetic wave reflector.

The wave-directing matching member, which may be integrated with the radiation element, is arranged to be disposed between the radiation element and the window glass of a target object. This configuration facilitates the transmission of electromagnetic radiation between them. The electromagnetic wave reflector is positioned further away from the window glass relative to the radiation element.

The wave-direction matching member is configured to match a wave path reflected from the air side of the combination of the wave-direction matching member and the window glass, in order to align the distance to a surface of the radiation element to maintain a standing wave condition expressed as 0.5nλ_{g} in the direction of a radiation path R of a main lobe, where n is an integer and λ_{g} is the resultant wavelength of the medium at a predetermined center frequency. It is noted that the inclusion of 0.5λ_{g} in the above function accounts for the 180-degrees phase change due to the reflection from the window glass.

The thickness between an outermost edge of the window glass and the electromagnetic reflective ground along the radiation direction R is denoted as D, and a total relative resultant permittivity of a medium between the interior side edge of the window glass and the radiating element is denoted as εᵣ; the medium comprising the window glass of the target object, any wave-direction matching members (which may include an air gap or a metal strip affecting phase change), and the dielectric radiation element, and, if present, the RF substrate with its feeding circuit, a dielectric substrate, or an air space gap located above the reflective ground beneath the radiation element, wherein D is calculated as D=d+0.5nλ_{g}, where n is an integer greater than or equal to 1 and less than 8, with n most likely being 1 to 4, and predominantly 2; d represents the total thickness tolerance, ranging from −0.125λ_{g} to +0.125λ_{g}, λ_{g} denotes the resultant wavelength in the medium at a predetermined center operating frequency, and the radiation direction R is defined as originating from or directed towards the radiation element.

Optionally, the target object for the antenna attached is the window glass of a building, window glass of an automobile, window glass of a wall or the window glass of any object/device/machine.

Optionally, the dielectric radiation element is a dielectric resonator antenna, a dielectric via formation antenna, a dielectric dense patch antenna, a dielectric loaded conductive radiating element, a dielectric loaded slot antenna, a dielectric loaded horn antenna, a dielectric loaded SIDRA, a dielectric loaded patch antenna, a dielectric resonator magnetoelectric dipole antenna, or any combination thereof;

Optionally, the antenna device may include only one or more than one radiation element and these different radiation elements may be the same type or different types of radiation elements with the resultant dielectric constant of said dielectric radiation element is greater than 4, to maintain a resonating mode that enables radiation resonance upon coupling with the electromagnetic wave from or into the signal feed-line.

Optionally, the dielectric radiation element is part of a dielectric resonator antenna array. Optionally, the antenna device comprises a dielectric resonator antenna array and the radiation element is part of the dielectric resonator antenna array.

Optionally, the dielectric radiation element is substantially optically transparent (i.e., is made of substantially optically transparent material(s)). For example, the radiation element may have a transparency or light transmittance (in respect of visible light) of over 70%, over 80%, over 90%, over 95%, or over 99%.

Optionally, the dielectric radiation element is made of one or more kind glass or crystal or ceramic materials.

Optionally, the dielectric radiation element may be partially formed from a dielectric material of any shape, wherein the resultant dielectric constant of said dielectric radiation element is greater than 4, to maintain a resonating mode that enables radiation resonance upon coupling with the electromagnetic wave from or into the signal feed-line.

Optionally, the dielectric radiation element is made of sapphire glass (Al₂O₃), soda lime glass or crystal glass.

Optionally, the wave-directing matching member comprises a resultant dielectric medium that includes at least one dielectric element and one or more dielectric substrates or space gaps; the resultant dielectric constant of this medium differs from the dielectric constant of the dielectric radiation element of claim 1 by no more than 3, and differs from the dielectric constant of the window of the target object by no more than 3;

Optionally, the wave-directing matching member may be either separate from or integrated with the dielectric radiation element.

Optionally, the wave-directing matching member is made of one or more solid dielectric materials, each with a dielectric constant higher than 3.

Optionally, the wave-direction matching member is made of at least one of borosilicate glass, soda lime glass crystal glass and lead glass.

Optionally, the wave-direction matching member may be partially formed from dielectric material with any shape.

Optionally, the wave-direction matching member may be loaded with a metal strip to induce a phase shift affecting the distance D. This additional phase shift will be incorporated into the total distance condition D=d+0.5nλg.

Optionally, the wave-direction matching member is substantially optically transparent (i.e., is made of substantially optically transparent material(s)). For example, the matching member may have a transparency or light transmittance (in respect of visible light) of over 70%, over 80%, over 90%, over 95%, or over 99%.

Optionally, the electromagnetic wave reflector is a conductive solid surface, a conductive meta-surface, a conductive net surface, a high dielectric substrate having a dielectric constant of at least 20, or any combination thereof, configured to reflect at least 50% of the electromagnetic waves at the desired frequency, likely exceeding 70%, and serves as a reflective grounding for the antenna unit.

Optionally the antenna signal feeding circuit comprises various types of signal feeding mechanisms, including, but not limited to, Dielectric Resonator Antenna (DRA) ground slot-exciting feeding, DRA proximity feeding, dense patch proximity feeding, probe feeding, and side coupling feeding. These feeding types are capable of transferring or receiving signal coupling to the dielectric resonator element, and are applicable for configurations including single feed, dual feed, or multiple-input multiple-output (MIMO) feeds.

Optionally, the electromagnetic wave reflector comprises fully or partially conductive electrical materials, including but not limited to ITO (Indium Tin Oxide), metal mesh film, metal mesh glass, metal net, partially conductive patch, FTO (Fluorine-doped Tin Oxide), graphene, or other conductive materials.

Optionally, the electromagnetic wave reflector is substantially or partially optically transparent (i.e., is made of substantially optically transparent and electrically conductive material(s)).

Optionally, the electromagnetic wave reflector is fully or partially composed of materials with a very high dielectric constant, such as Zirconia, Lithium Niobate (LiNbO₃), high dielectric glass, and high-dielectric ceramics, which are capable of reflecting at least 50% of the desired frequency.

Optionally, the antenna device is substantially optically transparent. For example, the antenna device as a whole may have a transparency or light transmittance (in respect of visible light) of over 70%, over 80%, or over 90%.

Optionally, the dielectric radiation element is arranged in an offset or angled configuration relative to the wave-directing matching member to achieve bent radiation patterns directed either inwardly or outwardly from the window glass, thereby creating one or more additional refractive paths that maintain resonance with the window glass and produce a superimposed radiation directivity pattern.

Optionally, the antenna unit contains two wave-direction matching members which are respectively configured inside and outside the window glass, to achieve resonance along the window glass direction and to guide the radiation waves to be radiated omnidirectionally around the dielectric radiation element and the window glass.

Optionally, the wave-direction matching member is dome-shaped to introduce a phase shift affecting the distance D towards the wider angle direction. This additional phase shift, including the air, will be incorporated into the total distance condition D=d+0.5nλg for a wider angle, as specified for the distance D.

Optionally, a low-dielectric constant sticker, with a dielectric constant ranging from 2 to 3.5 (assuming the window glass has a medium dielectric constant εᵣ of over 6), attached to the outermost sides of the window glass or dielectric matching member, is an optional choice for further enhancing gain and reducing reflections by the window glass.

In a second aspect, there is provided a method for forming an antenna device attached structure. The method includes attaching the antenna device of the first aspect to the structure such that the wave-directing matching member is disposed between the dielectric radiation element and the window glass of the structure.

In a third aspect, there is provided a dielectric resonator antenna device for attaching to a structure. The dielectric resonator antenna device includes a dielectric resonator antenna with a dielectric resonator element, and a matching member for operably coupling with, or operably coupled with, the dielectric resonator element. The matching member is arranged to be disposed between the dielectric resonator element and the structure to facilitate transmission of electromagnetic radiation between the dielectric resonator element and the structure when the dielectric resonator antenna device is attached to the structure. The dielectric resonator element is arranged to have a first dielectric constant or effective dielectric constant. The matching member is arranged to have a second dielectric constant or effective dielectric constant smaller than the first dielectric constant or effective dielectric constant. The dielectric resonator antenna device of the fourth aspect may be considered as a specific example of the antenna device of the first aspect. Any feature(s) described herein in relation to the antenna device of the first aspect may thus be applicable to the dielectric resonator antenna device of the fourth aspect, as appropriate and applicable.

In a fourth aspect, there is provided an antenna device attached structure. The antenna device attached structure includes a structure and the dielectric resonator antenna device of the fourth aspect attached to the structure with the matching member is disposed between the radiation element and the structure. The structure may be attached with multiple ones of the dielectric resonator antenna device of the fourth aspect.

In a fifth aspect, there is provided a dielectric resonator antenna array device for attaching to a structure. The dielectric resonator antenna array device comprises dielectric resonator antenna array with multiple dielectric resonator elements, and a matching member for operably coupling with, or operably coupled with, the dielectric resonator elements. The matching member is arranged to be disposed between the dielectric resonator elements and the structure to facilitate transmission of electromagnetic radiation between the dielectric resonator elements and the structure when the dielectric resonator antenna array device is attached to the structure. Each of the dielectric resonator element is arranged to have a first dielectric constant or effective dielectric constant. The matching member is arranged to have a second dielectric constant or effective dielectric constant smaller than the first dielectric constant or effective dielectric constant. The dielectric resonator antenna array device of the sixth aspect may be considered as a specific example of the antenna device of the first aspect. Any feature(s) described herein in relation to the antenna device of the first aspect may thus be applicable to the dielectric resonator antenna array device of the sixth aspect, as appropriate and applicable.

In a sixth aspect, there is provided an antenna device attached structure. The antenna device attached structure includes a structure and the dielectric resonator antenna array device of the sixth aspect attached to the structure with the matching member is disposed between the radiation element and the structure. The structure may be attached with multiple ones of the dielectric resonator antenna array device of the sixth aspect.

In some embodiments, the antenna device in one or more of the above aspects can operate in one or more millimeter wave bands such as but not limited to the 3.5 GHz band, 5-6 GHz band, the 12 GHz band and the 28 GHz band, the 60 GHz band.

In some embodiments, the antenna device in one or more of the above aspects can operate as a transmit antenna device and/or a receive antenna device.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

Terms of degree such as ‘generally,’ ‘about,’ ‘substantially,’ or the like are used depending on context to account for manufacturing tolerance, degradation trends, tendencies in practical applications, etc. For example, when a value is modified by terms of degree such as ‘about,’ such expression includes the stated value ±15%, ±10%, ±5%, ±2%, or ±1%. Unless otherwise specified, ‘substantially optically transparent’ as used herein generally refers to a transparency or light transmittance (in respect of visible light) of over 70%.

Unless otherwise specified, the terms ‘connected,’ ‘coupled,’ ‘mounted,’ ‘attached,’ or the like are intended to encompass both direct and indirect connection, coupling, mounting, attachment, etc.

### BRIEF DESCRIPTION OF THE DRAWINGS

Some embodiments of the invention are now described, by way of example, with reference to the accompanying drawings in which:

FIG. 1 is a schematic diagram of an electromagnetic wave passing a medium in an environment;

FIG. 2 is a schematic diagram of an antenna device attached structure according to an embodiment, where the structure is window glass;

FIG. 3 is a schematic diagram of an antenna device attached structure according to another embodiment, which contains a side low dielectric supporter;

FIG. 4 is a schematic diagram of an antenna device attached structure according to another embodiment, with a wave-directing matching member arranged outside a window glass;

FIG. 5 is a schematic diagram of an antenna device attached structure according to another embodiment, where the wave-directing matching member is offset from the radiation member;

FIG. 6 is a schematic diagram of a dielectric resonator antenna device attached structure in one embodiment;

FIG. 7 is a schematic diagram (side view) of an antenna device attached structure in one embodiment;

FIG. 8 is a graph showing measured gain (dBi) of the antenna device attached structure of FIG. 7 (with matching layer), the antenna device attached structure of FIG. 7 (without matching layer), and a reference dielectric resonator antenna (no matching layer and not attached to structure), from 3 GHz to 4.5 GHz;

FIG. 9 is a schematic diagram (disassembled perspective view) of a dielectric resonator antenna in one embodiment;

FIG. 10 is a top view of the dielectric resonator antenna of FIG. 9;

FIG. 11 is a sectional side view of the dielectric resonator antenna of FIG. 9;

FIG. 12 is a graph showing simulated reflection coefficients (|S₁₁|, dB) and gain (dBi) of the dielectric resonator antenna of FIG. 9 and when it is matched to a window, from 3 GHz to 5.5 GHz;

FIG. 13A is a plot showing simulated radiation patterns of the dielectric resonator antenna of FIG. 9 and when it is matched to a window, at 3.6 GHz;

FIG. 13B is a plot showing simulated radiation patterns of the dielectric resonator antenna of FIG. 9 and when it is matched to a window, at 4.7 GHz;

FIG. 14 is a graph showing simulated gain (dBi) at θ=o⁰ of the dielectric resonator antenna of FIGS. 9-11, the dielectric resonator antenna attached to a structure (without matching layer), and the dielectric resonator antenna attached to a structure (with matching layer), from 3.2 GHz to 5.0 GHz;

FIG. 15 is a graph showing simulated reflection coefficients (|S₁₁|, dB) and simulated gain (dBi) at θ=o⁰ of the dielectric resonator antenna of FIG. 9 attached to a structure (with matching layer) and the dielectric resonator antenna device attached structure of FIG. 9, from 3 GHz to 5.5 GHz;

FIG. 16 is a graph showing a perspective view of a dielectric antenna array according to one embodiment of the invention, featuring four dielectric radiating elements attached to window glass and including a wave-directing matching member;

FIG. 17 is a graph showing a perspective view of a two-ports dielectric antenna, featuring one dielectric radiating elements;

FIG. 18A is a graph showing a structure diagram of the face indoor side view of the two-ports dielectric antenna of FIG. 17;

FIG. 18B is a graph showing a structure diagram of the face outdoor to window side view of the two-ports dielectric antenna of FIG. 17;

FIG. 19A is a graph showing the perspective view of the installation diagram of the two-ports dielectric antenna of FIG. 17, applying to attach to the window with a wave-directing matching member;

FIG. 19B is a graph showing the side view of the installation diagram of the two ports dielectric antenna of FIG. 17, attached to the window with a wave-directing matching member;

FIG. 20 is a graph showing simulated reflection coefficients and isolation of the two ports dielectric resonator antenna of FIG. 17;

FIG. 21A is a graph showing the simulated gain (dBi) at θ=0° for port 1 of the dielectric resonator antenna from FIG. 17, ranging from 3.0 GHz to 4.0 GHz;

FIG. 21B is a graph showing the simulated gain (dBi) at θ=0° for port 2 of the dielectric resonator antenna from FIG. 17, ranging from 3.0 GHz to 4.0 GHz;

FIG. 22A is a graph of the simulated E-plane radiation patterns at θ=0° for port 1 of the dielectric resonator antenna at 3.5 GHz;

FIG. 22B is a graph of the simulated H-plane radiation patterns at θ=0° for port 1 of the dielectric resonator antenna at 3.5 GHz;

FIG. 22C is a graph of the simulated E-plane radiation patterns at θ=0° for port 2 of the dielectric resonator antenna at 3.5 GHz;

FIG. 22D presents a graph of the simulated H-plane radiation patterns at θ=0° for port 2 of the dielectric resonator antenna at 3.5 GHz;

FIG. 23 is a graph depicting the antenna installation for tuning the radiation angle;

FIG. 24A is a graph showing the E-field distribution within the matching medium installed in the antenna from FIG. 17, where the offset distance to the DRA is 0 mm;

FIG. 24B is a graph showing the E-field distribution within the matching medium installed in the antenna from FIG. 17, where the offset distance to the DRA is 20 mm;

FIG. 25A is a graph of the radiation pattern from Port 1 with a 20 mm offset placement of the matching medium, achieving a 30-degrees radiation angle;

FIG. 25B is a graph of the radiation pattern from Port 2 with a 20 mm offset placement of the matching medium, achieving a 30-degrees radiation angle;

FIG. 26 is a graph depicting the antenna from FIG. 17 with a 20 mm offset and a 15-degrees tilt angle to the matching medium, achieving a 45-degrees radiation angle;

FIG. 27 is a side view of a dielectric resonator antenna in one embodiment that has omnidirectional attaching to the glass sky-window.

FIG. 28 is a perspective view of the dielectric resonator antenna in FIG. 27 that has omnidirectional attaching to the glass sky-window.

FIG. 29 depicts a dielectric antenna implementation on window transmission according to another embodiment of the invention.

FIG. 30 shows the measured S parameters of the dielectric antenna implementation of FIG. 29.

FIG. 31A and FIG. 31B show respectively the radiation patterns for Port 1 and Port 2 of the dielectric antenna implementation of FIG. 29.

FIG. 32 illustrates an example of implementing a dielectric matching medium method according to an embodiment of the invention for a phased array.

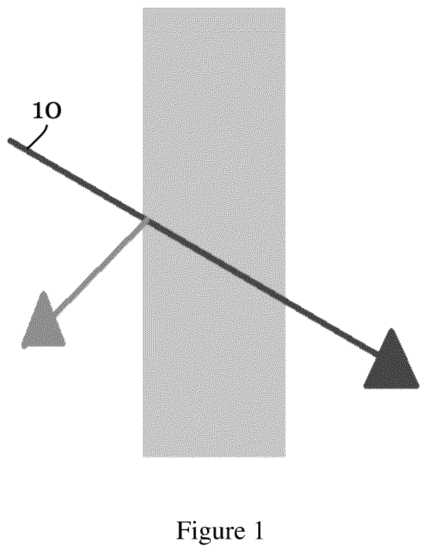

### DETAILED DESCRIPTION

In light of the shortcomings associated with conventional methods, it is essential to enhance the penetration of electromagnetic waves through a medium, which aids in transmitting electromagnetic waves from an antenna and facilitating their reception. According to this theory, the first technical approach involves ensuring that the difference in dielectric constant between two mediums (such as a neighboring substrate like a window) does not exceed 3, allowing for wave transmission and reception from the antenna unit to the window without significant reflection.

As the edge of the window, where the dielectric constant is high (normally over 6), reflection occurs along with a 180-degrees phase change, directing the wave back towards the antenna. To address this, an additional reflection is created from the window's exterior edge to the electromagnetic ground reflector, maintaining a 360-degrees superposition after two reflections from the window's exterior edge and the ground reflector. This requires a critical distance of 0.5nλg (where n is an integer of 0 or more) between the furthest edge of the window glass and the reflection ground surface, while ensuring this distance remains within +15 degrees to guarantee satisfactory radiation beamwidth performance. This parameter is defined as D=d+0.5nλg, where D represents the distance between the outer edge of the window and the outer edge of the radiating element, d denotes the total thickness tolerance ranging from −0.125λg to +0.125λg, λg signifies the resultant wavelength in the medium at a predetermined center operating frequency, and the radiation direction R is defined as originating from or directed towards the radiation element. Thus, after the back-and-forth reflections by the window's exterior edge and the ground reflector, a 360-degrees superposition of the reflected electromagnetic wave is maintained as it passes through the window without adversely affecting the signal.

However, at the window's edge, where the dielectric constant is high, reflection occurs along with a 180-degrees phase change, directing the wave back towards the antenna. Thus, another approach involves creating an additional reflection from the window's exterior edge to the electromagnetic ground reflector, maintaining a 360-degrees superposition after two times reflection by exterior edge of the window and the ground reflector. A critical distance, described as 0.5nλg (where n is an integer of 0 or more), is required between the furthest edge of the window glass system and the reflection ground surface. This distance must be kept within at least +/−15 degrees radian difference to ensure satisfactory in radiation beamwidth performance. This parameter is defined as D=d+0.5nλg (where n is an integer of 0 or more). The distance D is defined as the back and forth between the outer edge on the exterior side of the window and the outer edge on the exterior side of the radiating element, with d represents the total thickness tolerance, ranging from −0.125λ_{g} to +0.125λ_{g}, 2_{g} denotes the resultant wavelength in the medium at a predetermined center operating frequency, and the radiation direction R is defined as originating from or directed towards the radiation element. Therefore after back and forth reflection by exterior edge of the window and the ground reflector, a 360-degrees superposition with be maintained for the reflected electromagnetic wave getting through the window by the reflection without affect the signal without reflection.

Embodiments of the invention introduce alternative antenna designs, for example a dielectric antenna for attachment to the window glass of a target object. It utilizes a wave-directing matching member to augment the FB ratio by employing a double reflection reduction mechanism based on the principle of maintaining a proximity of nλg (where n is an integer starting from zero) between the exterior edge of the entire window glass assembly and the electro-magnetic ground reflector of the antenna.

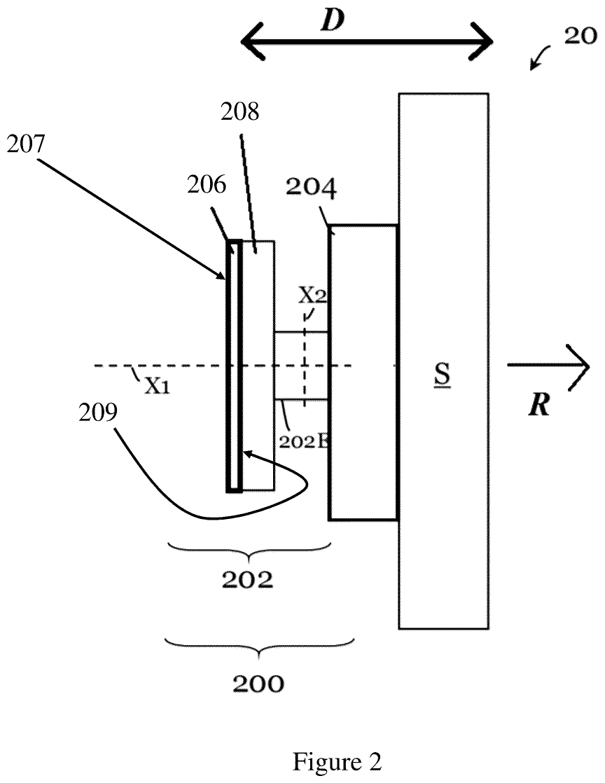

FIG. 2 depicts an antenna unit attached to a target object 20 according to one embodiment of the invention. The antenna device's attached structure 20 typically includes an antenna unit 200 affixed to a first side of a structure which is denoted as S. The antenna unit 200 may be either permanently or removably attached to the structure S.

The structure S in this embodiment is a window glass, which may consist of one or more layers of glass or crystal dielectric materials. It is usually designed to be substantially optically transparent. The structure S can serve as window glass for a building, house, cabin, room, an automobile, or a window glass of a device, system, or chamber. This window glass can also function as a glass cover for various devices, systems, or chambers, such as a lamp cover. The structure S-window glass can be either flat or curved. The thickness of the structure S-window glass is preferably between 1.0 to 20 mm, more preferably between 3.0 to 15 mm, and even more preferably from 3 mm to 6 mm.

The antenna unit 200 generally comprises a dielectric antenna 202 with one or more radiation elements 202E, and a wave-directing matching member 204. For simplicity, only one radiation element 202E is depicted in FIG. 2 and is further described below. The antenna 202 includes an RF dielectric substrate 206, fabricated on one side with an electromagnetic wave ground reflector 209, and on the opposite side with a feeding circuit 207. A dielectric substrate 208 is positioned between the radiation element 202E and the electromagnetic reflector ground 209.

The radiation element 202E is operably coupled with the dielectric substrate assembly 206. The substrate 206 is made from one or more solid dielectric materials, preferably partially or substantially optically transparent, such as glass or crystal. The surface 209 serves as an electromagnetic wave ground reflector and is constructed from electrically conductive materials, ideally being optically transparent or partially so. Common materials for the electromagnetic reflector ground plane include metal mesh (with mesh holes smaller than ¼λ to ensure effective reflection), transparent conductive materials such as Indium Tin Oxide (ITO) and Fluorine-doped Tin Oxide (FTO), or any combination thereof;

The feed mechanism can be a slot or strip feed mechanism, featuring a feed line arrangement (with one or more feed lines) 207 located on the side of the substrate opposite the ground plane. A slot is formed in the electromagnetic reflector ground plane 209. As shown in FIG. 2, the feed line (not shown) is positioned on surface 207. The slot and feed line arrangement intersect in a plane view. The feed lines are made from electrically conductive materials, which may be transparent or non-transparent, such as silver or copper.

The wave-directing matching member 204, operably coupled with the radiation element 202E, is positioned between the radiation element 202E and the structure S to facilitate the transmission of electromagnetic radiation between the radiation element 202E and the structure S (when the antenna device 200 is attached to the structure S). Specifically, the wave-directing matching member 204 may aid in transmitting electromagnetic radiation from the radiation element 202E to the structure S and/or vice versa.

Optionally, the main lobe of the antenna 202 can be angled by adjusting the wave-directing matching member 204.

Additionally, the wave-directing member 204 can serve as a stair-guide of dielectric constants. For instance, there could be three pieces of dielectric substrate comprising the wave-directing member with dielectric constants εᵣ₂ₐ, ε_{r2b}, ε_{r2c}. The resultant dielectric constant difference between each neighboring substrate should not exceed 3, and the substrate thickness should be sufficient to prevent more than 24% reflection. The side of the substrate εᵣ₂ₐ attached to the window should not differ in dielectric constant from the window by more than 3, thus avoiding over 40% reflection, and similarly, the antenna-attached side of the substrate ε_{r2c} should not have a dielectric constant difference of more than 5 compared to the resultant dielectric of the antenna unit, again avoiding over 40% reflection. This principle is also applicable for more than three pieces of dielectric substrate as the wave-directing member, as long as the restriction of not exceeding a dielectric difference of more than 3 with the neighboring substrate is followed.

The wave-directing matching member 204 may be directly attached to the structure S via one or more of: mechanical means (e.g., fasteners, housing, etc.), chemical means (e.g., bonding agent such as adhesives), electromagnetic means (e.g., magnets, electromagnets), etc. The wave-directing matching member 204 may be in the form of a sheet or a layer, which may be curved (e.g., concave, convex) or substantially planar. The wave-directing matching member 204 may have even or uneven thickness. The shape of the wave-directing matching member 204 may conform to a shape of the structure S.

The wave-directing matching member 204 may be made of one or more solid dielectric materials, preferably substantially optically transparent, e.g. one or more glass or crystal materials. In some examples, the wave-directing matching member 204 may be made of glass such as borosilicate glass, crystal glass, soda-lime glass or lead glass.

The antenna 202 may be a dielectric resonator antenna, a dielectric via formation antenna, a dielectric dense patch antenna, a dielectric loaded conductive radiating element, a dielectric loaded slot antenna, a dielectric loaded horn antenna, a dielectric loaded SIDRA, a dielectric loaded patch antenna, a dielectric resonator magnetoelectric dipole antenna, or any combination thereof; the resultant dielectric constant of said dielectric radiation element is greater than 4, to maintain a resonating mode that enables radiation resonance upon coupling with the electromagnetic wave from or into the signal feed-line. In some examples, the radiation element 202E may be made of soda lime glass. crystal glass, sapphire glass (Al₂O₃), aluminium oxide, or other low loss high dielectric ceramic. The dielectric constant or effective dielectric constant of the dielectric radiation element 202E may be at least 4 at the operation frequency/frequencies of the antenna device 200. The radiation element 202E may have a transparency or light transmittance (in respect of visible light).

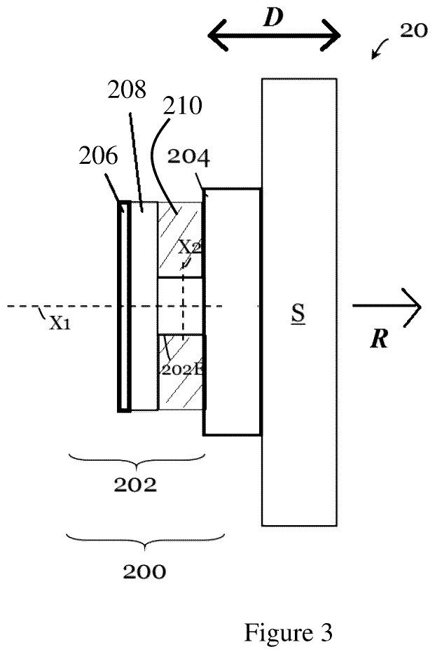

In variations of the exemplary embodiment shown in FIG. 2, depending on implementations, the antenna device 200 or the antenna 202 may include additional component(s), for example those as shown in FIGS. 3-5.

In particular, in the embodiment shown in FIG. 3, the antenna device 200 or the antenna 202 also includes a support member 210 supporting the radiation element 202E. Other aspects of the antenna device 200 shown in FIG. 3 are similar to those in FIG. 2, so they will not be described again for the sake of brevity. The support member 210 may define a space that receives the radiation element 202E, e.g., such that the radiation element 202E is embedded in or surrounded by the support member. In the example shown in FIG. 3, a central interior space is formed within the support member 210 to receive therein the radiation element 202E. The thickness/height (e.g., along axis X₁) of the support member 210 may be larger than the thickness/height (e.g., along axis X₁) of the radiation element 202E. The support member 210 may be made of one or more solid dielectric materials, preferably substantially or partially optically transparent, e.g. one or more thermoplastic polymer materials or thermoplastic resins. In some examples, the support member 210 may be made of Polydimethylsiloxane (PDMS) or Cyclic Olefin Copolymer (COC), which have dielectric constants smaller than the dielectric constant of the dielectric radiation element 202E over 3. The support member 210 may be molded on or injected around the radiation element 202E.

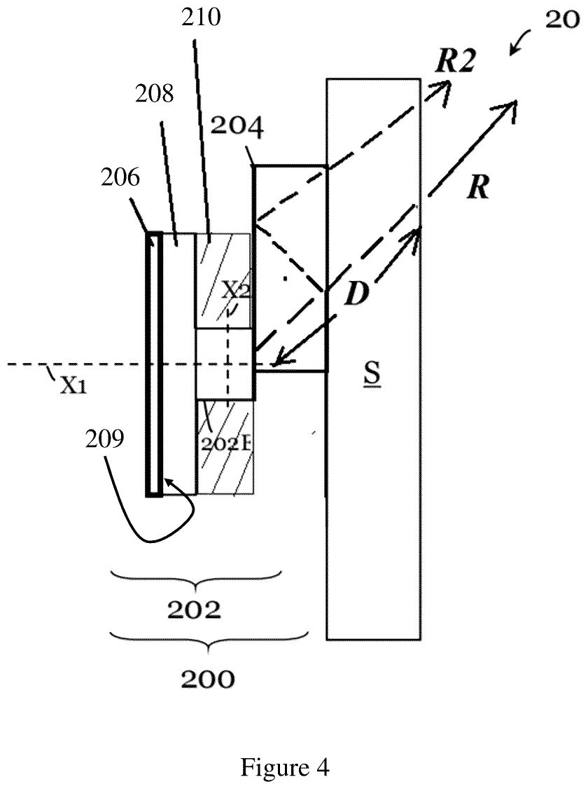

Turning to FIG. 4, in which an antenna device 200 according to a further embodiment of the invention is illustrated. Most aspects of the antenna device 200 shown in FIG. 4 are similar to those in FIG. 3, so they will not be described again for the sake of brevity. The only difference is that in FIG. 4, the wave-directing matching member 204, while still being on the same, first side of the structure S as in FIG. 3, is offset so that the axis X₁ does not pass through a center of the wave-directing matching member 204. Rather, as shown in FIG. 4 the antenna 202, the wave-directing matching member 204 and the structure S form a cascading shape at their top ends. The distance D between the radiating element 202E and the indoor edge of the structure S is also changed as compared to that in FIG. 3. The radiation path R is also changed as compared to that in FIG. 3.

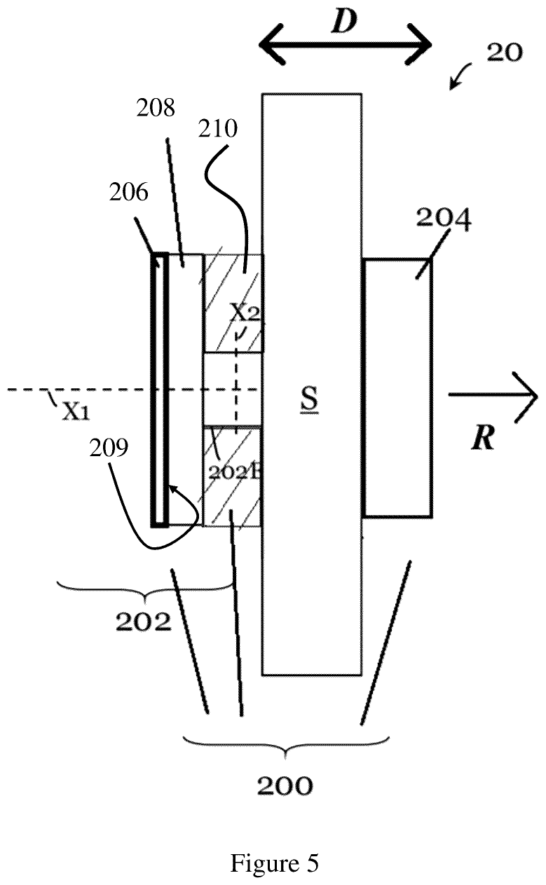

Turning to FIG. 5, an antenna device 200 according to a further embodiment of the invention is illustrated. Most aspects of the antenna device 200 shown in FIG. 5 are similar to those in FIG. 3, so they will not be described again for the sake of brevity. The only difference is that in FIG. 5, the additional dielectric window member 204 is located at the outermost edge of the window on the outdoor side. This affects the definition of the distance D in this embodiment. The distance D is defined as the distance between the electromagnetic reflector 209 and the outermost edge of the additional dielectric window member 204, where the dielectric constant of the extra dielectric window member is greater than 4.

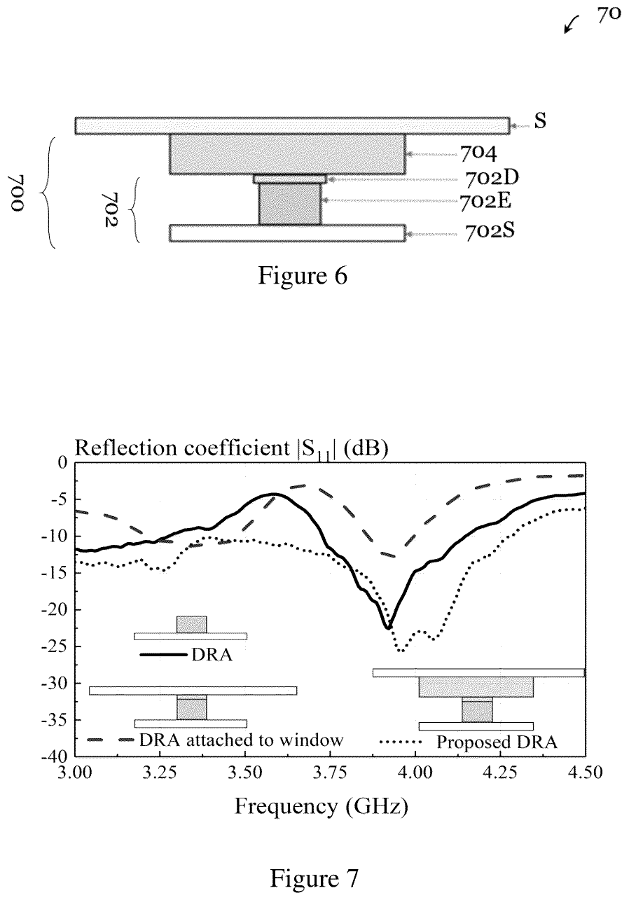

FIG. 6 shows a 3.8 GHz linearly polarized (LP) unidirectional dielectric resonator antenna device attached structure 70 used in the experiment for proving a function of wave-directing matching member to help to radiation and return loss. In this example the structure S is window glass (400×400×6 mm³). As shown in FIG. 6, the antenna device attached structure 70 includes a dielectric resonator antenna device 700 attached to a structure S. The dielectric resonator antenna device 700 includes a dielectric resonator antenna 702 and a wave-directing matching member 704 disposed between the dielectric resonator antenna 702 and the structure S. The dielectric resonator antenna 702 includes a RF substrate 702S with feedline circuit and reflective ground plate, an Al₂O₃ ceramic 702E with a dielectric constant of 10 and a size of 20×20×20 mm³ placed on the RF substrate 702S, a quartz crystal layer 702D (20×20×1 mm³) placed on top of the Al₂O₃ ceramic 702E. The FR-4 wave-directing matching member 704 (90×60×15 mm³) is placed on top of the quartz crystal layer 702D, between the quartz crystal layer 702D and the window glass S (400×400×6 mm³). In this example the FR4 wave-directing matching member 704 is provide by a bare FR4 printed circuit board without copper clad. The Al₂O₃ ceramic 702E may operates as radiation element of the antenna. The quartz crystal layer 702D may operate as a part of wave-direction matching member for further fine tune the reflective path.

In the experiments, three different example antennas variated from FIG. 6, are investigated as shown in FIG. 7: (1) a simple dielectric resonator antenna with a dielectric radiator element mounted on a substrate assembly (without matching medium and not attached to any structure) (“DRA”), (2) a simple dielectric resonator antenna without matching medium but attached to window glass (“DRA attached to window”), and (3) the antenna device attached structure 70 with the antenna device 700 attached to the window glass S (“Tested DRA”). For these example antenna devices, the S-parameters are measured with an Agilent vector network analyzer N5230A whereas the realized antenna gains (mismatch included) are measured using a Satimo StarLab system.

FIG. 7 shows the measured reflection coefficients (|S₁₁|, dB) of the three antenna devices. As shown in FIG. 7, the wave-directing matching member can improve the return loss of the antenna matching condition when the antenna device is attached to a window glass. The bandwidth of the antenna device attached structure 70 attached to the window glass is more than 35.16% (3.00 GHz to 4.28 GHz, with center frequency 3.64 GHz), which is almost 3 times that of the simple dielectric resonator antenna without matching medium and not attached to window glass (10.28%, 3.70 GHz to 4.13 GHz).

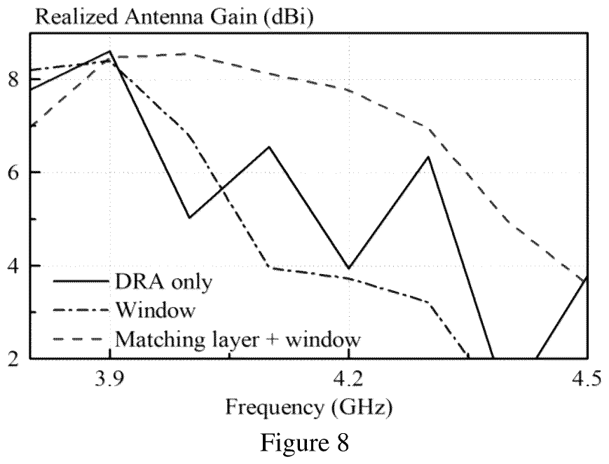

FIG. 8 shows the measured gain (dBi) of the three antenna devices depicted in FIG. 7. As illustrated, when a glass window S is attached to the front of the antenna device, the antenna gain deteriorates. However, with the addition of the wave-directing matching member, the gain of the antenna device is restored and exceeds the gain of the antenna device without the glass window. In this example, a maximum gain of more than 8 dBi is achieved for the antenna device structure 70.

Rechecking the calculations, the total thickness of the wave-direction matching member (FR4 substrate 704), the quartz glass (702D), and the window is as follows: “15 mm with Erbb 4.4=0.404λg@3.85 GHz”+“6 mm wave-directing matching member with εᵣ 6.85=0.202λg@3.64 GHz”+“1 mm another wave-directing matching member with Er3.78=0.025λg@3.85 GHz.” The thickness of the dielectric radiation element is “20 mm with εᵣ 10@3.85 GHz=0.81λg.” The distance D for this example is calculated as 0.404+0.202+0.025+0.812=1.443λg. This value fits the requirement of being close to 1.5λg when setting n=3 in the condition D=d+0.5nλg, with d being −0.057.

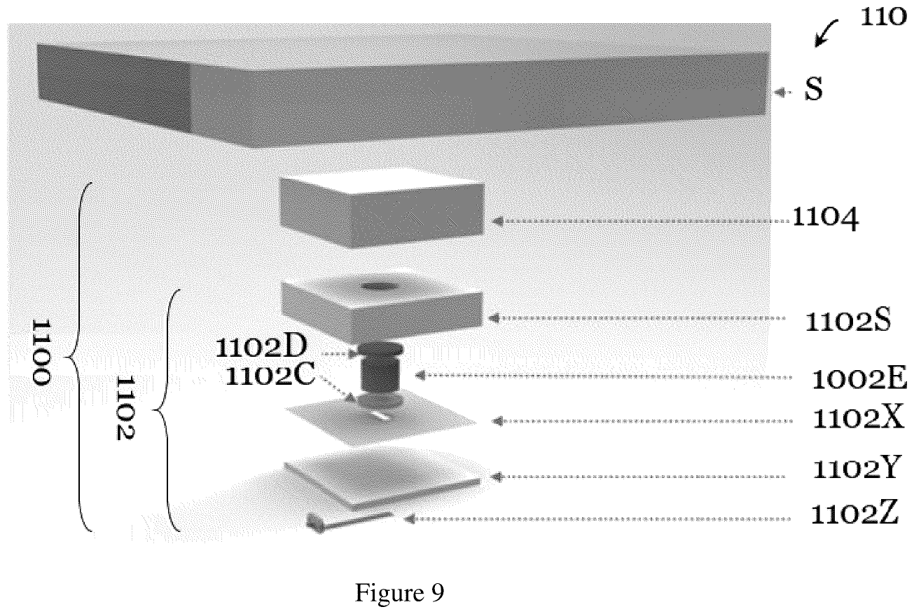

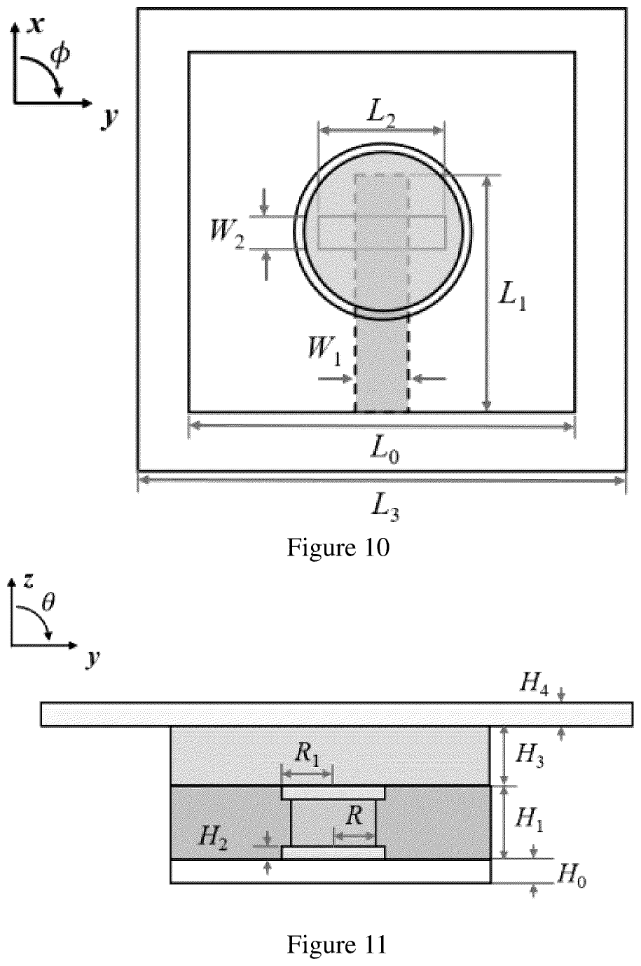

FIGS. 9, 10 and 11 illustrate a dielectric resonator antenna 1102 as part of a dielectric resonator antenna device 1100 which is in turn part of a dielectric resonator antenna device attached structure 110. The detailed parameter values of the dielectric resonator antenna device attached structure 110 and its components as illustrated in FIG. 10 and FIG. 11, in one specific implementation, are provided in Table 1 below.

TABLE 1
Dimensions of the antenna as shown in FIGS. 10-11

| H₀ | H₁ | H₂ | H₃ | H₄ | R |
|---|---|---|---|---|---|
| 1.1 mm | 8.6 mm | 1 mm | 20 mm | 3 mm | 12 mm |

| R₁ | W₁ | W₂ | L₀ | L₁ | L₂ | L₃ |
|---|---|---|---|---|---|---|
| 14 mm | 1.74 mm | 1 mm | 50 mm | 35.4 mm | 19 mm | 200 mm |

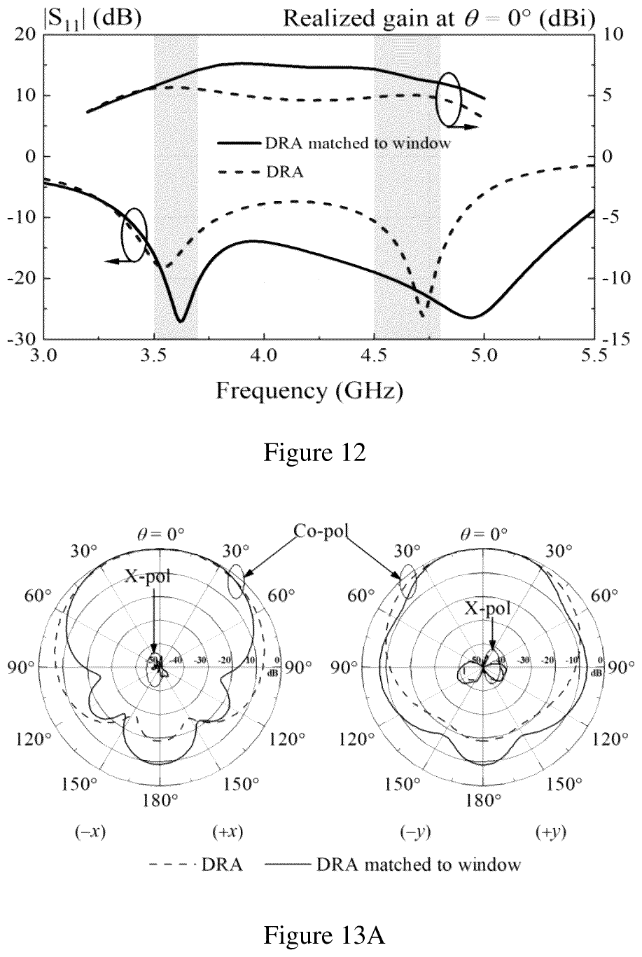

FIG. 12 shows the simulated reflection coefficient and the peak realized gain of the dielectric resonator antenna 1102 in FIGS. 9-11, and when it is matched to a window (e.g., as in. For the dielectric resonator antenna 1102, the 10 dB impedance bandwidths are 12.6% (3.35 GHz to 3.80 GHz) and 9.0% (4.47 GHz to 4.89 GHz) at lower and upper bands, respectively, whereas the simulated peak realized gains are 5.60 dBi and 4.81 dBi at 3.6 GHz and 4.7 GHz, respectively. For the dielectric resonator antenna device 1100 in the dielectric resonator antenna device attached structure 110, the 10 dB impedance bandwidth is 47.3% (3.37¬GHz to 5.46 GHz), which covers two low frequency 5G operating bands. For the dielectric resonator antenna device 1100 in the dielectric resonator antenna device attached structure 110, the middle band matching is improved over the antenna 1102 alone, and a wideband performance is achieved. Moreover, the wave-directing matching member 1104, which functions as the dielectric matching medium, aids in matching the antenna 1102 to the required distance D. For this example, at the desired center frequency of 4.25 GHz, the distance D is calculated as the sum of guided wavelengths in various layers:
Guided wavelength in window glass of thickness H4: 0.108λg
Guided wavelength in the dielectric matching medium 1104 (εᵣ=4.5) of thickness H3: 0.601λg
Guided wavelength in upper part of dielectric resonator antenna (εᵣ=6.75) of thickness H2: 0.037λg
Guided wavelength in main part of dielectric resonator antenna (εᵣ=9.3) with thickness (H1−H2*2):0.285λg
Guided wavelength in lower part of dielectric resonator antenna (εᵣ=6.75) of thickness H2: 0.037λg

Summing these values yields 1.068λg, which closely aligns with the condition D=d+0.5nλg, where n=2 and d=0.068λg. This configuration ensures that the design meets the spatial requirements set by the design parameters.

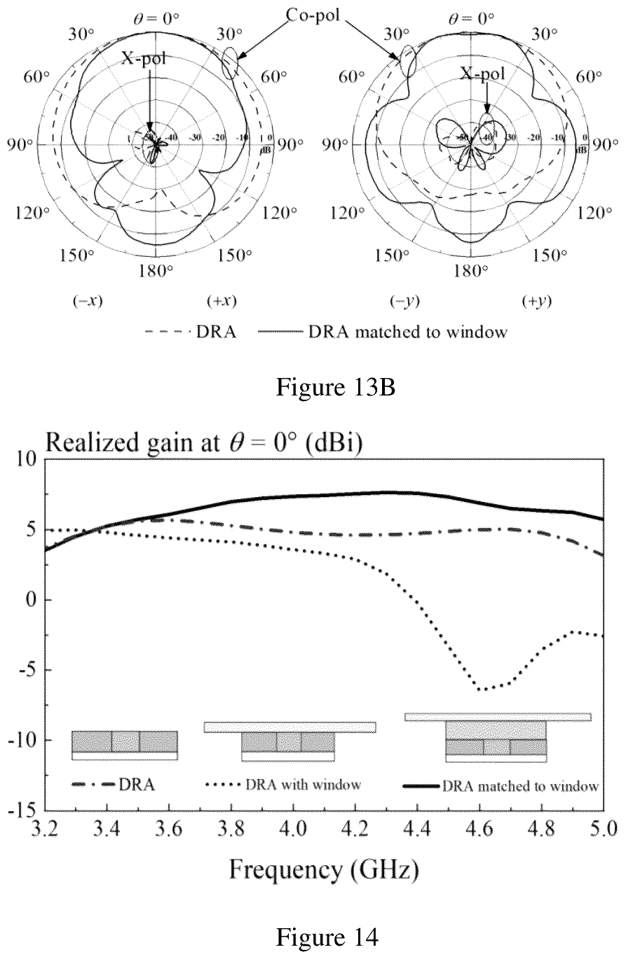

FIGS. 13A and 13B show the simulated radiation patterns of the two designs, the dielectric resonator antenna 1102 and the dielectric resonator antenna device 1100 in the dielectric resonator antenna device attached structure 110, at 3.6 GHz (lower band) and 4.7 GHz (upper band) respectively. The dielectric resonator antenna device 1100 in the dielectric resonator antenna device attached structure 110 has a smaller beam width and most of the radiation is directed towards the window glass S.

FIG. 14 shows simulated gain (dBi) at θ=o⁰ of the dielectric resonator antenna 1102 of FIGS. 9-11, the dielectric resonator antenna 1102 attached to a window glass S (without matching layer), and the dielectric resonator antenna 1102 attached to the window glass S (with matching layer), at different operation frequencies. As shown in FIG. 14, for the dielectric resonator antenna attached to the window glass without wave-directing matching member, the gain of the antenna drops. For the antenna attached to the window glass S with the wave-directing matching member, the forward gain of the antenna improves across substantially the entire frequency band. FIG. 14 therefore illustrates the significant improvement achieved by applying a dielectric matching medium that adheres to the proposed design rule.

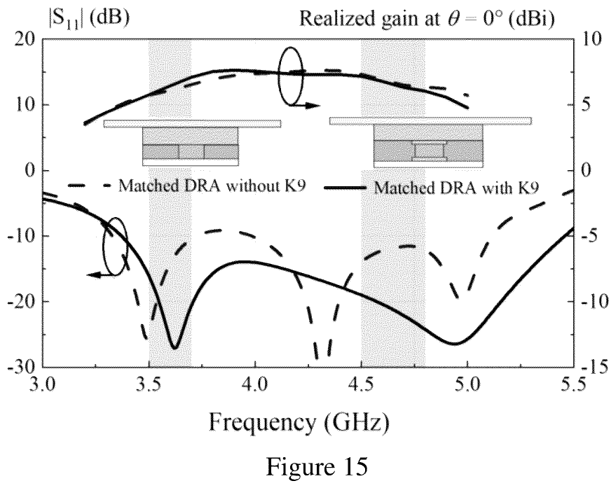

FIG. 15 displays the simulated reflection coefficients (|S₁₁|, dB) and simulated gain (dBi) at θ=0° for the dielectric resonator antenna of FIGS. 9-11, which is attached to a structure with a matching layer, and for the dielectric resonator antenna device attached to the structure shown in FIGS. 9-11, at different operating frequencies. The key difference between these two designs is that one includes two K9 crystals while the other lacks them. It is evident from FIG. 15 that the design incorporating the K9 crystals (εᵣ=6.5) facilitates a better dielectric transition from the main DRA (εᵣ=9.3) to the matching medium (εᵣ=4.5), resulting in fewer reflections during layer transitions. Consequently, the impedance matching performance is improved.

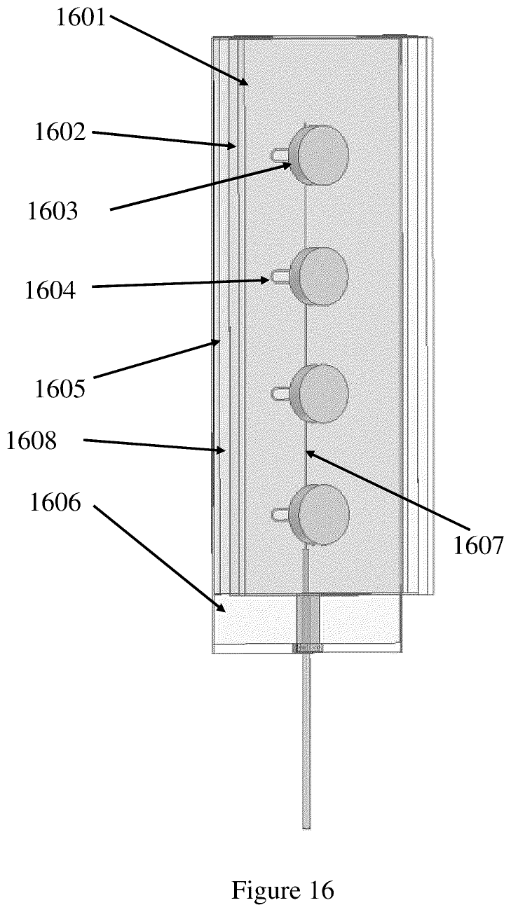

FIG. 16 depicts a dielectric antenna array with four radiation elements 1603 and a wave-directing matching member 1602 attached to a window 1601. The antenna includes an RF dielectric substrate 1606, which has an electromagnetic wave ground reflector 1605 fabricated on one side and a feeding circuit 1607 on the opposite side. A dielectric substrate 208 is positioned between the radiation element 1603 and the electromagnetic reflector ground 1609. This antenna also maintains the condition D=d+0.5nλg, where D is the distance between the window 1601 and the electromagnetic ground reflector.

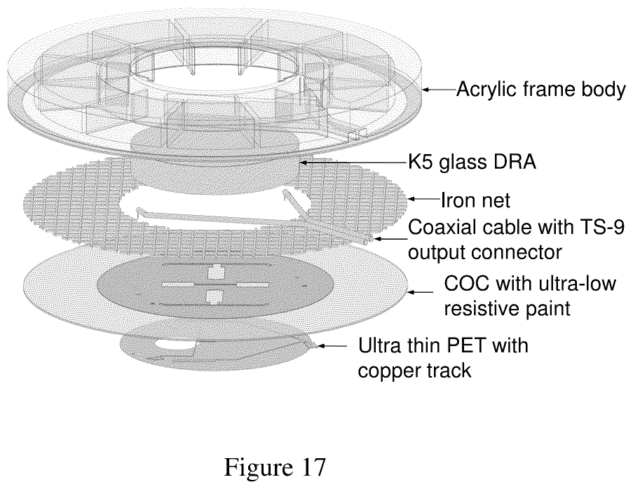

FIG. 17 depicts a dielectric antenna implementation on window transmission based on the antenna of FIG. 4, and in particular FIG. 17 shows the configuration of the 3.5 GHz band transparent planar glass antenna with embedded glass DRA. It consists of a cylindrical dielectric resonator (DR) glass K9 and installed in an air cavity with Acrylic support housing. A piece of COC (Cyclo-Olefin Copolymer) transparent plastic plate is applied to be the RF substrate and a copper track is mounted on one side of COC and another side are printed the ground slots by ultra-low loss silver printing paste. An iron square net is placed around the DRA to provide a see-through ground reflector to enhance the reflection.

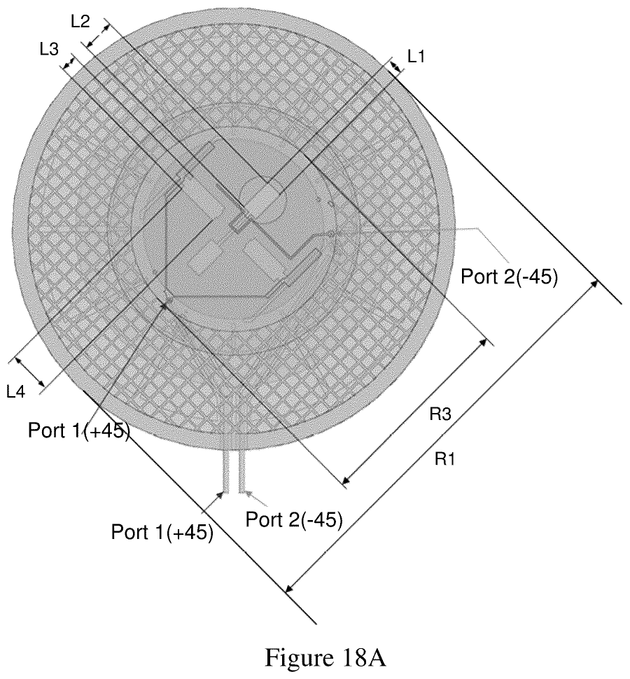

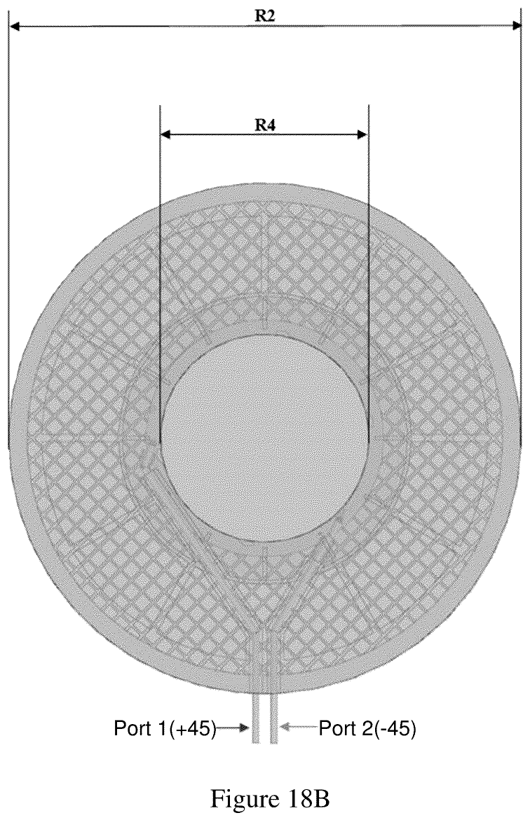

FIG. 18a and FIG. 18b depict the critical dimensions of the antenna in FIG. 17. In FIG. 18a, one can clearly see the first-ever invented two-layer symmetrical dual-port feeding for the DRA. The symmetrical structure helps to maintain good orthogonal performance for +45 and −45 degrees linear polarization. The detailed parameter values are shown in Table 2. Two layer structure is needed, not only regarding to cheaper in cost, but also to have more easier to design a transparent structure.

TABLE 2
The dimension of the proposed antenna

| R1 | R2 | R3 | R4 | H1 | H2 |
|---|---|---|---|---|---|
| 37.5 mm | 100 mm | 65 mm | 130 mm | 3 mm | 15 mm |
| H3 | L1 | L2 | L3 | L4 | |
| 11.4 mm | 5.375 mm | 10.925 mm | 5.644 mm | 14.157 mm | |

Note that the size of DRA is having diameter R1 (37.5 mm) and height H1 (10 mm). The materials used is K5 which has a dielectric constant 6.1 and loss at 0.001. It determines the fundamental center frequency of the antenna.

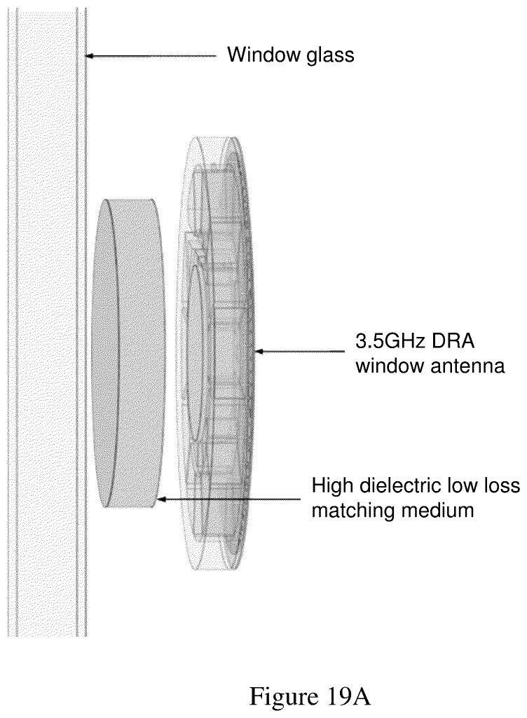

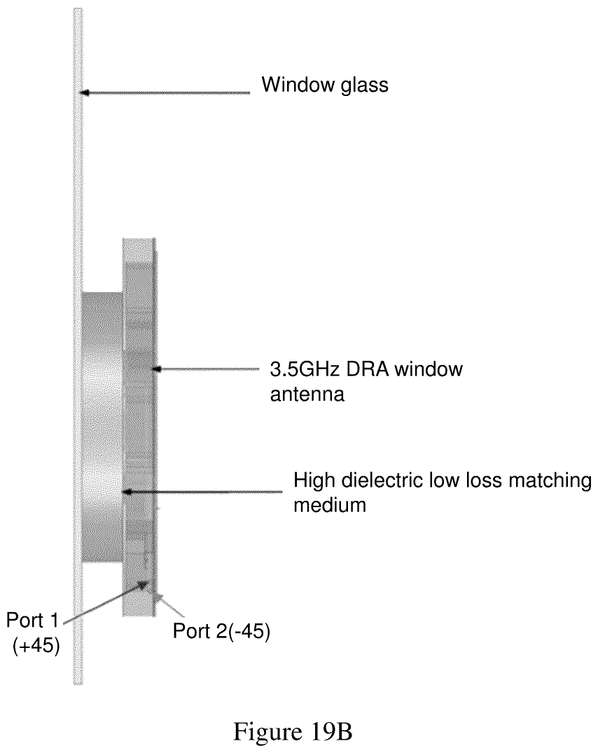

FIG. 19A and FIG. 19B show the installation of the antenna of FIG. 17 attached to the window after a matching medium member has been applied between them. After installation of the antenna, one has the follow result when the matching medium is placed in the center of the proposed antenna.

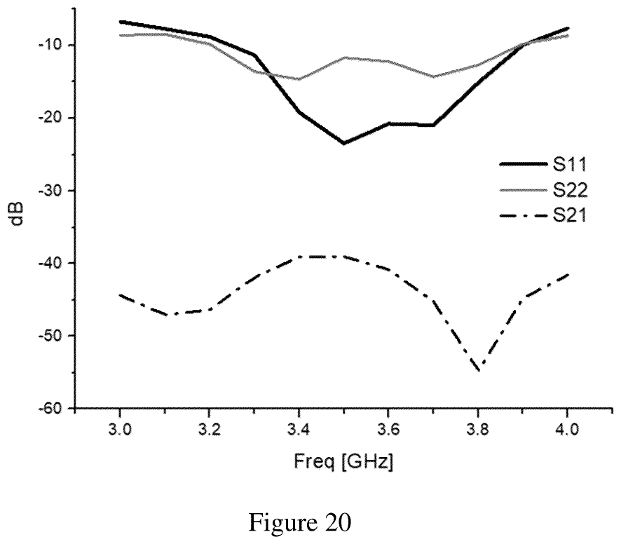

With reference to FIG. 20, the measured-10 dB impedance passband for Port 1 (+45 degrees) is 3.2 GHz-3.6 GHz for the antenna of FIG. 17. For Port 2 (−45 degrees), it shows a wider bandwidth across more than 3 GHz-4 GHz. Both are covering the required bandwidth 3.3-3.6 GHz for 5G application. The isolation for the required passband is nearly −40 dB. It would provide a beneficial factor to maintain a high data rate reception for low noise figure by lower noise floor.

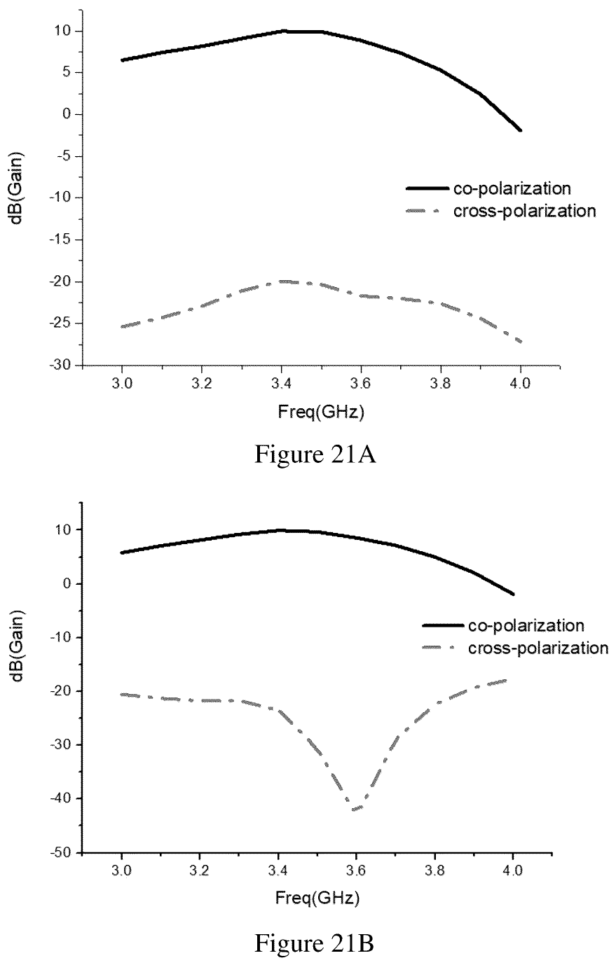

FIG. 21A and FIG. 21B illustrate the gain plot for the antenna of FIG. 17. The gain range for Port 1 is between 9.5 dB and 10.2 dB over the passband of 3.3 GHz to 3.6 GHz. For Port 2, the gain range is from 8.7 dB to 9.5 dB over the same passband of 3.3 GHz to 3.6 GHz. It can be observed that the cross-polarization isolation exceeds 25 dB for both Port 1 and Port 2 throughout the passband. This also contributes to high data rate reception due to the low noise floor.

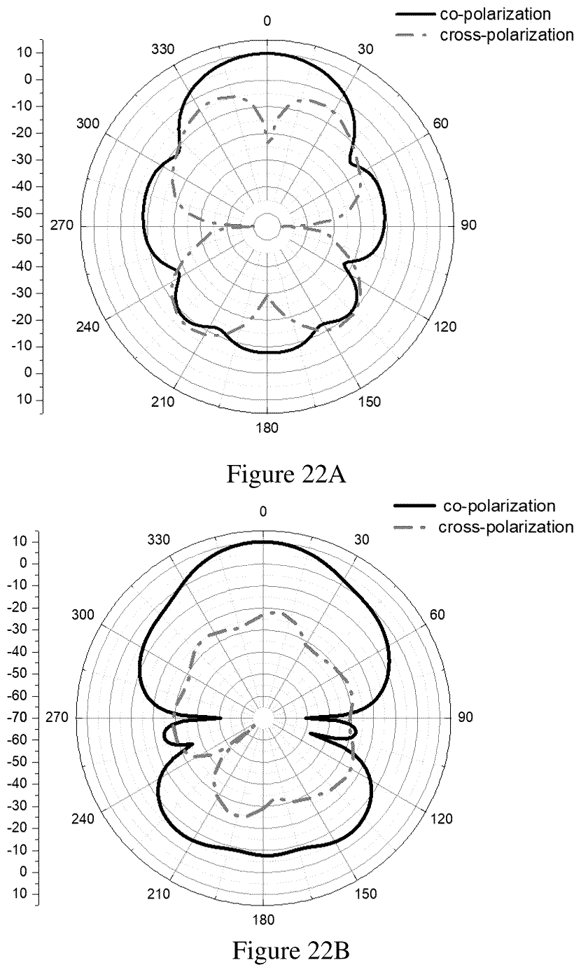

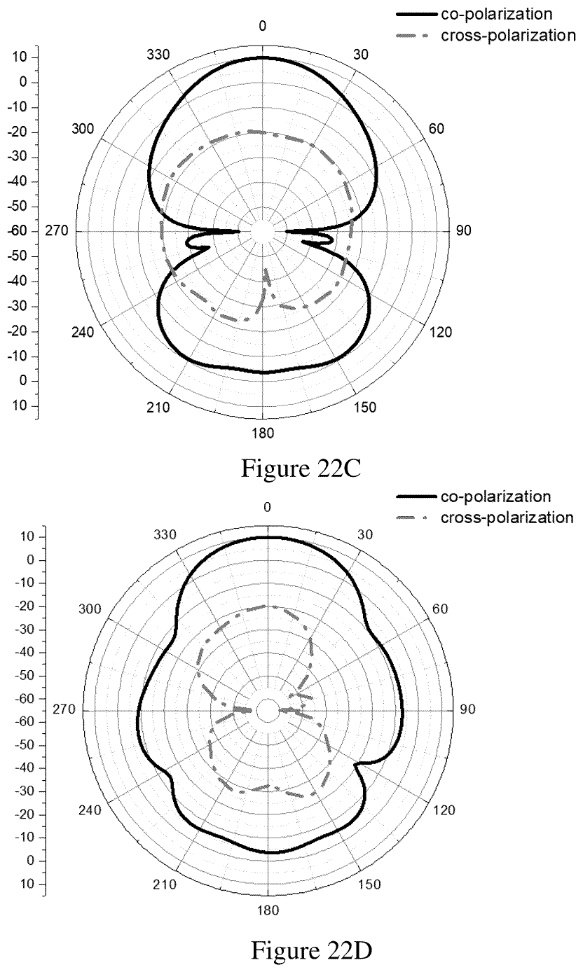

FIGS. 22A-22D show the radiation patterns for Port 1 and Port 2. The patterns tell a symmetric radiation pattern is given by Port 1 and Port 2. Note that even the F/B ration is not very large, however as the backlobe is radiated to the indoor behind the window, the contribution of background noise from unwanted signal is little.

The thickness of the matching medium is 18 mm, designed to match a 3 mm thick window glass. Typically, in homes or common commercial buildings, the thickness of window glass ranges from 3 mm to 8 mm; in homes, the most common thicknesses are 3 mm and 5 mm. The design allows for the matching medium to be thinner in order to accommodate thicker window glass. For example, if the window glass thickness is increased to 5 mm, then the thickness of the matching medium would be adjusted to 16 mm to compensate for this change. The maximum adjustment will allow the matching medium to be tuned for window glass thicker than 8 mm. This is to ensure that the combined thickness of the DRA and the matching medium remains greater than that of the window, to facilitate the establishment of the first order mode inside.

For replacing fixed network internet service with 5G network CPE service, there are generally two main markets. One is in crowded cities with high-rise buildings, and the other is in remote areas with houses. In crowded cities, the reception of CPE can be obstructed by neighboring buildings or the orientation of the windows in the user's apartment. Therefore, there is a need for at least a 45-degrees tuning to achieve a minimum of 4 dB gain for improved reception. Because cities generally have a higher 5G signal gain due to more base stations being installed nearby, many apartment units still receive a weaker signal. This occurs because the base station cannot cover direct signal transmission to every unit in the buildings; at least half of them may not have direct reception. Consequently, this results in weaker signal reception and lower data rates. The radiation angle-tunable antenna can help solve this blocking issue by assisting tenants with weaker signals to regain maximum reception. This solution can also help 5G service providers save on the need for additional base station installations and prevent data loss, thus enhancing system efficiency.

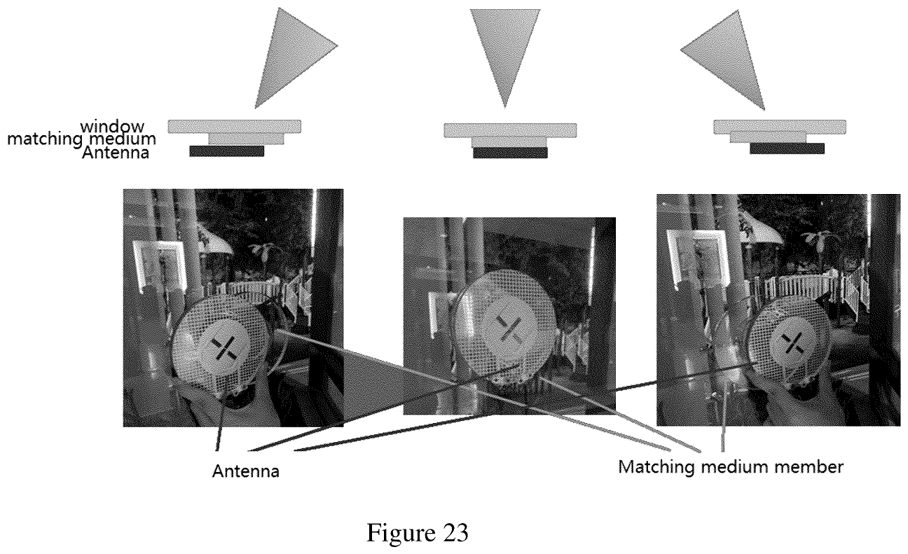

In FIG. 23, it demonstrates how the antenna of FIG. 17 adjusts its sticking position to help alter the radiation pattern. The prototype of the antenna is attached to the window after employing a matching medium member between them.

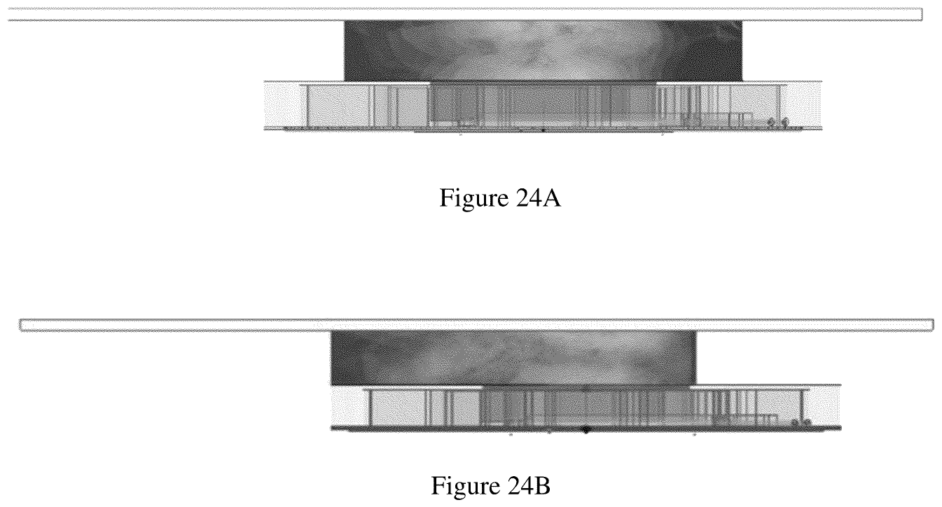

FIG. 24A and FIG. 24B illustrate how the E-field within the matching medium member of the antenna of FIG. 17 changes to alter the direction of the radiation pattern. In FIG. 24A, when the matching medium is positioned at the center of the antenna and directly above the glass DRA, the main E-field of the matching medium is located in the central part. Waves reflected from the window glass return to the antenna's ground, with a total path length of 1 λg. After being reflected by the ground plate, which causes a 180-degrees phase change, a path length of 2 λg (not including 2 times reflection total phase change 360-degrees by window and electromagnetic ground reflector) is maintained, becoming a resonant mode that radiates the electromagnetic field in the 0-degrees direction.

In FIG. 24B, the matching medium member is shifted so that over half its length extends beyond the top surface area of the DRA. Part of the electromagnetic wave inside the matching medium member is reflected and bounces to the sides of the medium. Since the space below the matching medium within the acrylic cavity is air, the significant dielectric difference causes the electromagnetic wave to reflect and bounce back towards the top surface of the window glass. This creates another resonant path, and radiation occurs towards the side direction. By superimposing the radiation from the original path and the new resonant path, a new, redirected radiation direction is developed.

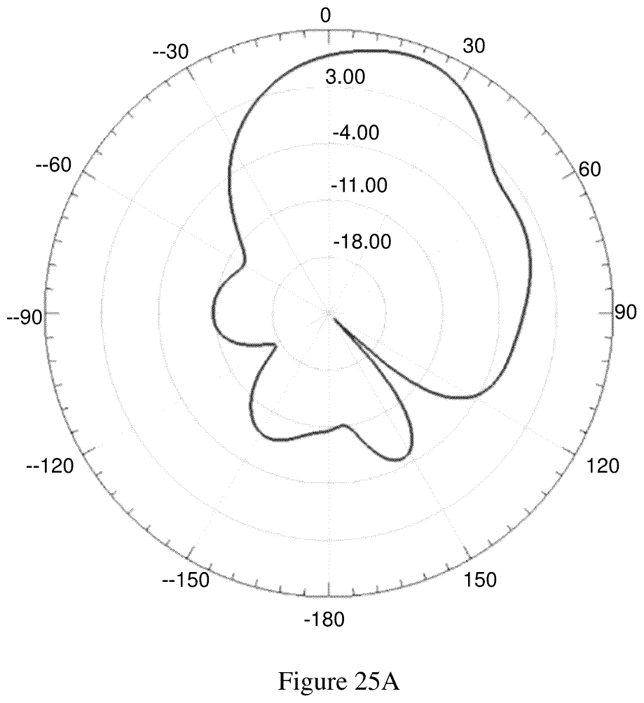

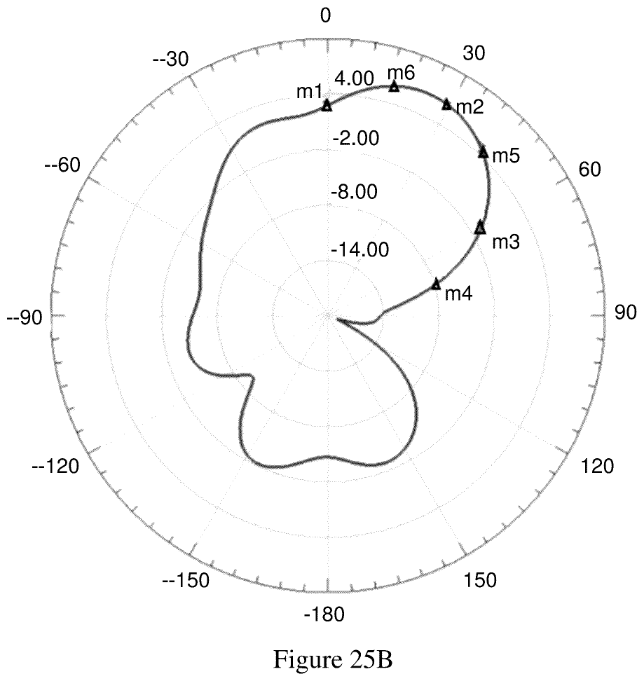

Since the antenna's feeding design is symmetrical, shifting to either side results in similar gains. Therefore, providing data for only one side is sufficient for depiction. The standard matching medium, which utilizes K5 glass, shows the radiation pattern for a 20 mm offset in FIG. 25A for Port 1 and FIG. 25B for Port 2.

The radiation gain at 30 degrees is enhanced by 1-1.5 dB is enough for the apartment window angle offset usage. An optional part would be provided to the user will be a higher lead glass materials made for providing dielectric constant Er.9 and loss 0.01.

Details data for offset 20 mm using higher dielectric constant matching medium member is listed in Table 3. It shows that this new component help the gain at the angle at 45 degrees enhanced more than 2 dB in order to have 4.25 dB gain reception.

TABLE 3
The peak gain of the antenna for using different
offset placement and different matching medium
at different angles.

| | | 20 mm | 20 mm |
|---|---|---|---|
| | | peak gain | offset using |
| Member | 0 mm | Using K5 | lead glass |
| offset | peak gain | glass | (Eᵣ = 9) |
| Port 1 | 0º: 10.13 dB | 0º: 5.51 dB | 0º: 2.61 dB |
| | 30º^{::} 5.89 dB | 30º^{::} 7.35 dB | 30º^{::} 6.97 dB |
| | 45º^{::} 2.15 dB | 45º^{::} 3.17 dB | 45º^{::} 4.51 dB |
| | 60º: −3.81 dB | 60º: 1.24 dB | 60º: −3.61dB |
| | 75º: −6.97 dB | 75º: 1.16 dB | 75º: −6.05 dB |
| Port 2 | 0º: 9.25 dB | 0º: 4.75 dB | 0º: 2.76 dB |
| | 30º^{::} 5.20 dB | 30º^{::} 6.25 dB | 30º^{::} 6.28 dB |
| | 45º^{::} 2.15 dB | 45º^{::} 2.3 dB | 45º^{::} 4.25 dB |
| | 60º: −0.05 dB | 60º: 0.83 dB | 60º: −0.748 dB |
| | 75º: −7.0 dB | 75º: 3.9 dB | 75º: −7.78 dB |

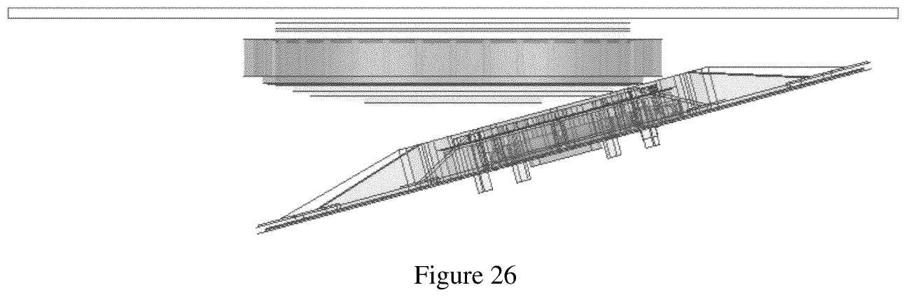

FIG. 26 is a graph showing the antenna from FIG. 17 with a 20 mm offset and a 15-degrees tilt angle to the matching medium, which bends the radiation pattern to achieve a 45-degrees peak gain angle. This illustrates that the antenna's placement is not confined to a parallel arrangement. The antenna may include various antennas with different types of radiation patterns, including omni-directional, directional, and multi-beam radiation.

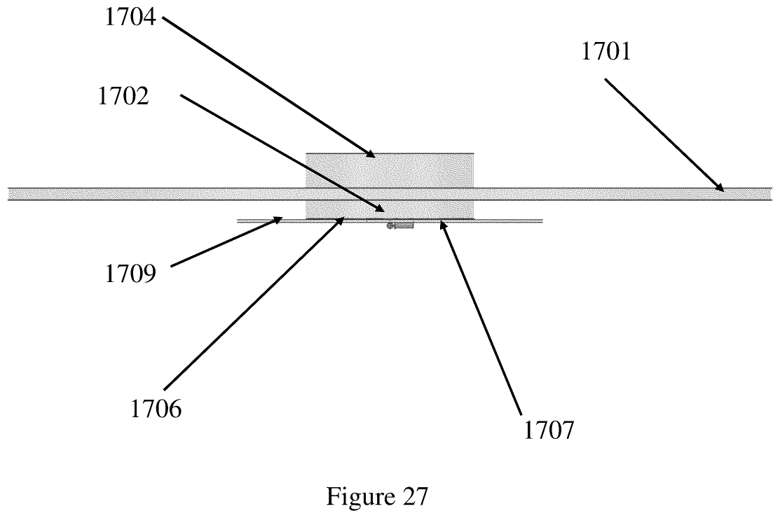

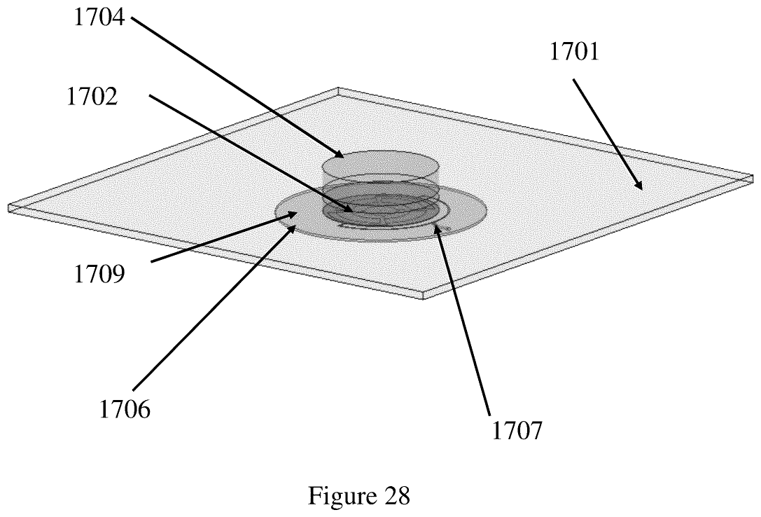

FIG. 27 and FIG. 28 depict a dielectric antenna implementation on window transmission based on the antenna of FIG. 5. The antenna includes an RF dielectric substrate 1706, fabricated on one side with an electromagnetic wave ground reflector 1709, and on the opposite side with a feeding circuit 1707. The radiation element 1702 (εᵣ=5.35) 1701 with thickness 5 mm. is positioned between the electromagnetic wave ground reflector 1708 and the acrylic window glass (εᵣ=6.35) 1701 with thickness 3 mm. The additional dielectric window member 1704 (εᵣ=6.35) 1701 with thickness 9 mm is located at the outermost edge of the window 1701 on the outdoor side. This affects the definition of the distance D in this embodiment. The distance D is defined as the distance between the electromagnetic reflector 1708 and the outermost edge of the additional dielectric window member 1704, where the dielectric constant of the extra dielectric window member is greater than 4.

For this example, at the desired center frequency of 3.5 GHz, the distance D is calculated as the sum of guided wavelengths in various layers:
Guided wavelength in window glass of thickness 3 mm: 0.064λg
Guided wavelength in the dielectric matching medium 1104 (εᵣ=6.35) of thickness 9 mm: 0.265λg
Guided wavelength in main part of dielectric resonator antenna (εᵣ=6.35) with thickness 5 mm: 0.145λg

Summing these values yields 0.474λg, which closely aligns with the condition D=d+0.5nλg, where n=1 and d=−0.026λg. This configuration ensures that the design meets the spatial requirements set by the design parameters.

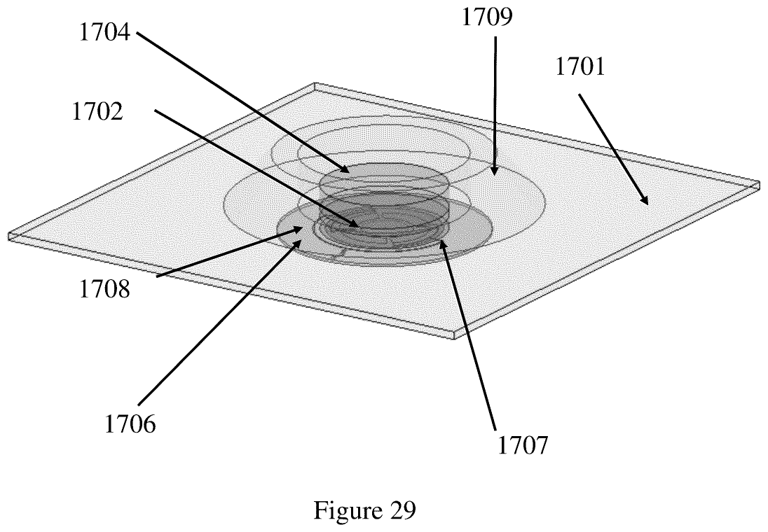

FIG. 29 depicts a dielectric antenna implementation on window transmission by improving the design in FIG. 28. The antenna includes an extra loading low dielectric cone cap covered on the dielectric matching member but on the window. It helps to alternating the directivity of the radiation to the direction parallel to the windows.

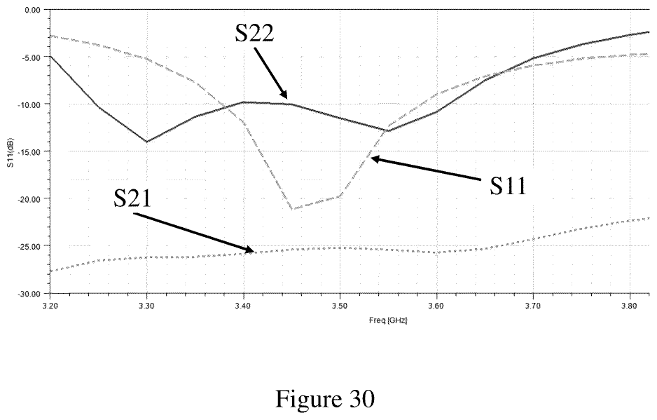

With reference to FIG. 30, the measured-10 dB impedance passband for Port 1 is 3.38 GHz-3.58 GHz. For Port 2, it shows a wider bandwidth across more than 3.25 GHz-3.62 GHz. The isolation S21 for the overlap bandwidth is nearly −25 dB.

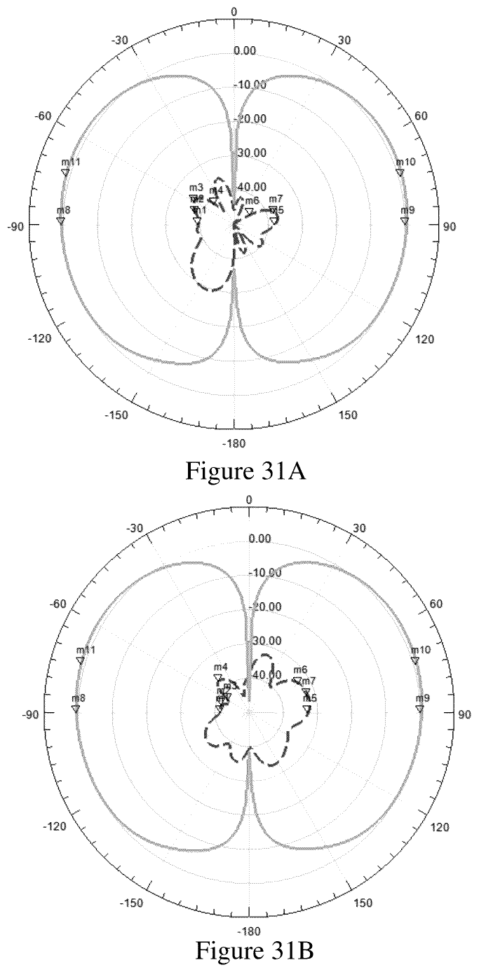

FIG. 31A and FIG. 31B show the radiation patterns for Port 1 and Port 2 respectively. The patterns tell a symmetric omnidirectional radiation pattern is given by Port 1 and Port 2.

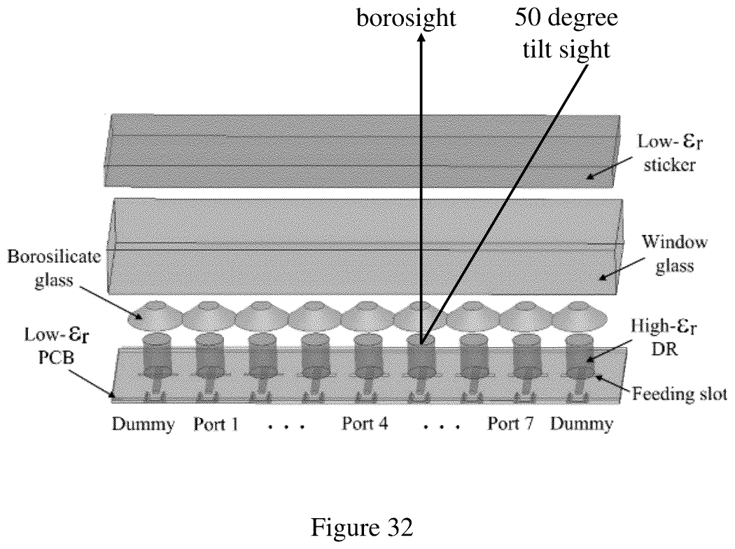

FIG. 32 illustrates an example of implementing the proposed dielectric matching medium method for a phased array, particularly suited to Ka-band applications. The cone-shaped dielectric medium member, made of borosilicate glass, helps to widen the radiation pattern's beamwidth to meet the Distance D requirement for broader directionality. In the boresight direction, the additional phase shift in λg corresponds to the thickness of the cone-shaped dielectric matching medium, taking into account its dielectric constant Er. When considering a 50-degree tilt angle, the additional phase shift results from the path traversing the cone-shaped dielectric medium member and the air space between this medium member and the windows. Assuming that these two paths yield approximately the same resultant phase shift in λg, they both effectively meet the Distance D requirement, thus enabling high gain results at wider angles.

Note that the Low-Er sticker, which has a dielectric constant ranging from 2 to 3.5 (assuming the window glass has a medium dielectric constant of over εᵣ 6), is an optional choice for enhancing gain and reducing reflections by the window glass.

One can see that the antenna devices according to exemplary embodiments of the invention can therefore facilitate electromagnetic wave penetration through a medium. The antenna devices according to some embodiment can further provide high gain. The antenna devices according to some embodiments can further provide high optical transparency. The antenna configuration enables the integration to excite a dielectric resonator antenna resonating mode that resonates at the resultant wavelength of the desired frequency with minimum unwanted reflection from the window glass. Through this integration, the antenna operates as a complete antenna unit with the window glass, radiating electromagnetic waves of desired frequency either inwardly to or outwardly from the window glass.

The antenna device in some embodiments of the invention can be used for fifth generation (5G) or above wireless communication and/or millimeter wave bands (3.5 GHz, 28 GHz, 60 GHz) applications. In one example, the antenna device can be configured as a 3.5 GHz substantially transparent planar MIMO antenna array to address problems associated with limited space for deploying base station antennas behind windows of buildings. In one example, the antenna device can be configured as a 28 GHz substantially transparent planar MIMO antenna attachable to window of vehicle to enable wide angle (e.g., 360 degree) 5G reception for reducing signal interruption. In one example, the antenna device can be configured as a 28 GHz substantially transparent planar transmit array antenna attachable to a window for connecting indoor repeaters to the base stations. The antenna device can be made substantially transparent to facilitate blending into the environment. It should be appreciated that the antenna device and the antenna device attached structure of the invention are not limited to these specific applications.

It will be appreciated by persons skilled in the art that numerous variations and/or modifications may be made to the invention as shown in the specific embodiments to provide other embodiments of the invention. The described embodiments of the invention should therefore be considered in all respects as illustrative, not restrictive. Example optional features of some aspects of the invention are set forth in the summary section above. Some embodiments of the invention may include one or more of these optional features (some of which are not specifically illustrated in the drawings). Some embodiments of the invention may lack one or more of these optional features (some of which are not specifically illustrated in the drawings). One or more features in one embodiment and one or more features in another embodiment may be combined to provide further embodiment(s) of the invention. For example, the shape, size, form, location, and/or orientation of the substrate may be different from those illustrated (e.g., cuboidal). For example, the shape, size, form, location, and/or orientation of the ground plane may be different from those illustrated (e.g., rectangular cross section). For example, the shape, size, form, location, and/or orientation of the radiator element may be different from those illustrated. For example, the shape, size, form, location, and/or orientation of the support member may be different from those illustrated. The antenna device may be arranged to operate in any one or more frequencies or frequency bands.

For example, an antenna product may offer a package that includes all components of the antenna unit element as described above in exemplary embodiments, wherein these components are intended to function collectively as a single unit when attached to window glass, and cannot be functionally or commercially separated without departing from the technology specified. The promotional materials for these products must expressly state that the complete integration of these components is necessary to achieve the performance characteristics of the technology as designed for attaching to window glass, thereby preventing the sale or use of individual components in a manner that would circumvent the patented technology.

1- An antenna unit element for attaching to a window glass of a target object, comprising:
a dielectric radiation element adapted to be positioned on a first side of the window glass; and
a dielectric wave-directing matching member adapted to be arranged between the window glass and the dielectric radiation element, or on a second side of the window glass; and
an electromagnetic wave reflector arranged to be positioned on the first side of the window glass, and located further from the first side of the window glass than the dielectric radiation element; and
an antenna signal feeding circuit configured to transmit electromagnetic signals to or receive electromagnetic signals from the dielectric radiation element for signal transmission or reception;
wherein the antenna unit element is configured to accommodate and match a thickness and a dielectric constant of the window glass.

2. The antenna unit element of claim 1, wherein a distance D is defined as the thickness measured from an outermost edge of the window glass to an electromagnetic reflective ground, with a measurement path passing through the dielectric radiation element along a radiation direction R; a total relative resultant permittivity (εᵣ) being defined for a medium which comprises the window glass of the target object and the dielectric radiation element; wherein the distance D is calculated as
D=d+0.5nλ_{g}
wherein n is an integer greater than or equal to 1 and less than 8, with n preferably being in the range of 1 to 4, and most preferably being 2; d representing a total thickness tolerance, ranging from −0.125λ_{g} to +0.125λ_{g}; λ_{g} denoting a resultant wavelength in the medium at a predetermined center operating frequency; and the radiation direction R being defined as originating from or directed towards the radiation element.

3. The antenna unit element of claim 1, wherein the target object is a building, an automobile, or a wall.

4. The antenna unit element of claim 1, wherein the dielectric radiation element is one of the followings: a dielectric resonator antenna, a dielectric via formation antenna, a dielectric dense patch antenna, a dielectric loaded conductive radiating element, a dielectric loaded slot antenna, a dielectric loaded horn antenna, a dielectric loaded SIDRA, a dielectric loaded patch antenna, a dielectric resonator magnetoelectric dipole antenna, or any combination thereof; a resultant dielectric constant of said dielectric radiation element being greater than 4.

5. The antenna unit element of claim 1, wherein the wave-directing matching member comprises a resultant dielectric medium that includes at least one dielectric element and one or more dielectric substrates or space gaps; the resultant dielectric constant of the dielectric medium differing from a dielectric constant of the dielectric radiation element by no more than 3, and differs from the dielectric constant of the window glass by no more than 3.

6. The antenna unit element of claim 1, wherein the wave-directing matching member comprises at least a part made of one or more solid dielectric materials, each with a dielectric constant higher than 3.

7. The antenna unit element of claim 1, wherein the antenna unit element is an external standalone antenna unit adapted to be connected with a radio device by signal cables, or with antenna components installed in a radio device/system.

8. The antenna unit element of claim 1, wherein the dielectric radiation element, the wave-directing matching member and the electromagnetic wave reflector are optically transparent, semi-transparent, or partially transparent.

9. The antenna unit element of claim 1, wherein the or each of the electromagnetic wave reflector comprises a conductive surface, a conductive net surface, a high-dielectric substrate having a dielectric constant of at least 20, or any combination thereof; the electromagnetic wave reflector configured to reflect at least 50% of electromagnetic waves at a predetermined center operating frequency, and preferably at least 70%, of the of electromagnetic waves; the electromagnetic wave reflector serving as an electromagnetic reflective ground for the antenna unit element.

10. The antenna unit element of claim 1, wherein the dielectric radiation element is at least partially made of one or more solid dielectric materials, each with a dielectric constant higher than 4.

11. The antenna unit element of claim 1, wherein the antenna signal feeding circuit comprises one or more of the followings: Dielectric Resonator Antenna (DRA) ground slot-exciting feeding, DRA proximity feeding, dense patch proximity feeding, probe feeding, and side coupling feeding.

12. The antenna unit element of claim 1, wherein the wave-direction matching member is loaded with a metal strip to induce a phase shift affecting the distance D.

13. The antenna unit element of claim 1, wherein the dielectric radiation element is arranged in an offset or angled configuration relative to the wave-directing matching member to achieve bent radiation patterns directed either inwardly or outwardly from the window glass.

14. The antenna unit element of claim 1, comprising two said wave-direction matching members which are respectively configured inside and outside the window glass.

15. The antenna unit element of claim 2, wherein the window glass of the target object is a double glazed window with a spacing of over 6 mm between inner and outer window glass panels, the distance D defined as a thickness measured from an outermost edge of the inner window glass panel on the first side of the window glass to the electromagnetic reflective ground.

16. The antenna unit element of claim 1, further comprising a dielectric window member located at an outermost edge of the window glass on the second side of the window glass; a distance D defined as a distance between the electromagnetic wave reflector and an outermost edge of the dielectric window member, where a dielectric constant of the dielectric window member is greater than 4.

17. The antenna unit element of claim 1, wherein the wave-direction matching member is dome-shaped to introduce a phase shift.

18. The antenna unit element of claim 1, further comprising a low-dielectric constant sticker with a dielectric constant ranging from 2 to 3.5, which is adapted to be attached to an outermost side of the window glass or that of wave-directing dielectric matching member.
